(19) United States
(12) Patent Application Publication
(10) Pub. No.: US 2024/0284514 A1
(43) Pub. Date: Aug. 22, 2024

(54) METHOD, USER EQUIPMENT, AND NETWORK NODE FOR FEATURE BASED RANDOM ACCESS PROCEDURE

(71) Applicant: Telefonaktiebolaget LM Ericsson (publ), Stockholm (SE)

(72) Inventors: Jonas SEDIN, Brentford, Greater London (GB); Zhipeng LIN, Nanjing, Jiangsu (CN)

(73) Assignee: Telefonaktiebolaget LM Ericsson (publ), Stockholm (SE)

(21) Appl. No.: 18/570,049

(22) PCT Filed: Apr. 21, 2022
(86) PCT No.: PCT/CN2022/088144

§ 371 Date: Dec. 13, 2023

(30) Foreign Application Priority Data
Jun. 18, 2021 (WO) PCT/CN2021/100922

(51) Int. Cl. H04W 74/0833

(52) U.S. Cl. CPC H04W 74/0833

(57) ABSTRACT

The present disclosure is related to a user equipment (UE), a network node, and methods for a feature based PRACH transmission. A method at a user equipment (UE) for performing a random access procedure with a network node comprises: receiving a configuration for physical random access channel (PRACH) transmission; determining a first PRACH resource, which is to be used for the PRACH transmission and indicates whether a feature is requested or not, at least partially based on the received configuration and one or more measurements at the UE; and transmitting, to the network node, the PRACH transmission by using the first PRACH resource.

### CROSS-REFERENCE TO RELATED APPLICATION(S)

This application claims priority to the PCT International Application No. PCT/CN2021/100922, entitled “METHOD, USER EQUIPMENT, AND NETWORK NODE FOR FEATURE BASED RANDOM ACCESS PROCEDURE”, filed on Jun. 18, 2021, which is incorporated herein by reference in its entirety.

### TECHNICAL FIELD

The present disclosure is related to the field of telecommunication, and in particular, to a user equipment (UE), a network node, and methods for a feature based random access procedure.

### BACKGROUND

With the development of the electronic and telecommunications technologies, mobile devices, such as a mobile phone, a smart phone, a laptop, a tablet, a vehicle mounted device, becomes an important part of our daily lives. To support a numerous number of mobile devices, a highly efficient Radio Access Network (RAN), such as a fifth generation (5G) New Radio (NR) RAN, will be required.

In order to be able to carry the data across the 5G NR RAN, data and information is organized into a number of data channels. By organizing the data into various channels, a 5G communications system is able to manage the data transfers in an orderly fashion and the system is able to understand what data is arriving and hence it is able to process the data in the required fashion. As there are many different types of data that need to be transferred-user data obviously needs to be transferred, but so does control information to manage the radio communications link, as well as data to provide synchronization, access, and the like. All of these functions are essential and require the transfer of data over the RAN.

In order to group the data to be sent over the 5G NR RAN, the data is organized in a very logical way. As there are many different functions for the data being sent over the radio communications link, they need to be clearly marked and have defined positions and formats. To ensure this happens, there are several different forms of data “channel” that are used. The higher level ones are “mapped” or contained within others until finally at the physical level, the channel contains data from higher level channels.

In this way there is a logical and manageable flow of data from the higher levels of the protocol stack down to the physical layer.

There are three main types of data channels that are used for a 5G RAN, and accordingly the hierarchy is given below.
Logical channel: Logical channels can be one of two groups: control channels and traffic channels:
   Control channels: The control channels are used for the transfer of data from the control plane; and
   Traffic channels: The traffic logical channels are used for the transfer of user plane data.
Transport channel: Is the multiplexing of the logical data to be transported by the physical layer and its channels over the radio interface.
Physical channel: The physical channels are those which are closest to the actual transmission of the data over the radio access network/5G Radio Frequency (RF) signal. They are used to carry the data over the radio interface.

The physical channels often have higher level channels mapped onto them for providing a specific service. Additionally, the physical channels carry payload data or details of specific data transmission characteristics like modulation, reference signal multiplexing, transmit power, RF resources, etc.

The 5G physical channels are used to transport information over the actual radio interface. They have the transport channels mapped into them, but they also include various physical layer data required for the maintenance and optimization of the radio communications link between a UE and a base station (BS).

There are three physical channels for each of the uplink and downlink: Physical Downlink Shared Channel (PDSCH), Physical Downlink Control Channel (PDCCH), and Physical Broadcast Channel (PBCH) for downlink, and Physical Random Access Channel (PRACH), Physical Uplink Shared Channel (PUSCH), and Physical Uplink Control Channel (PUCCH) for uplink.

### SUMMARY

According to a first aspect of the present disclosure, a method at a user equipment (UE) for performing a random access procedure with a network node is provided. The method comprises: receiving a configuration for physical random access channel (PRACH) transmission; determining a first PRACH resource, which is to be used for the PRACH transmission and indicates whether a feature is requested or not, at least partially based on the received configuration and one or more measurements at the UE; and transmitting, to the network node, the PRACH transmission by using the first PRACH resource.

In some embodiments, the first PRACH resource comprises at least one of:—a PRACH time/frequency resource; and—a PRACH preamble sequence. In some embodiments, the feature comprises at least one of:—Msg3 repetition;—MsgA repetition;—a network slice;—Non-small data transmission (Non-SDT);—a UE with reduced capability (RedCap UE);—a random access in non-terrestrial network; and—a specific service type or UE priority.

In some embodiments, the step of determining the first PRACH resource comprises: determining whether the feature is requested or not at least partially based on the received configuration and a first measurement at the UE; selecting one of multiple synchronous signal blocks (SSBs) broadcasted by the network node at least partially based on the received configuration and one or more second measurements at the UE; and determining the first PRACH resource at least partially based on the selected SSB and the determination of whether the feature is requested or not.

In some embodiments, the step of determining whether the feature is requested or not comprises: determining whether reference signal received power (RSRP) of a downlink pathloss reference, which is measured at the UE, is higher than or equal to a first threshold indicated by the received configuration or not; and determining that the feature is not requested in response to determining that the RSRP of the downlink pathloss reference is higher than or equal to the first threshold. In some embodiments, the step of determining whether the feature is requested or not comprises: determining whether RSRP of a downlink pathloss reference, which is measured at the UE, is higher than or equal to a first threshold indicated by the received configuration or not; and determining that the feature is requested in response to determining that the RSRP of the downlink pathloss reference is lower than the first threshold.

In some embodiments, the selected SSB is one of:—a first SSB that is first determined to have a measured RSRP higher than a second threshold indicated by the received configuration;—a second SSB that is first determined to have a measured RSRP higher than a third threshold indicated by the received configuration;—a third SSB having the highest measured RSRP that is higher than the second threshold;—a fourth SSB having the highest measured RSRP that is higher than the third threshold;—a fifth SSB having the highest measured RSRP that is lower than or equal to the second threshold;—a sixth SSB having the highest measured RSRP that is lower than or equal to the second threshold but higher than the third threshold;—a seventh SSB having the highest measured RSRP that is lower than or equal to the third threshold; and—an eighth SSB that is randomly selected and has a measured RSRP lower than or equal to the second threshold and/or the third threshold. In some embodiments, the second threshold is indicated by an information element (IE) “rsrp-ThresholdSSB” in the configuration, and the third threshold is indicated by a second IE in the configuration or jointly indicated by the IE “rsrp-ThresholdSSB” and a third IE in the configuration that indicates an offset.

In some embodiments, the step of determining the first PRACH resource at least partially based on the selected SSB and the determination of whether the feature is requested or not comprises at least one of: determining a PRACH resource, which is associated with the selected SSB and indicates the feature is not requested, as the first PRACH resource in response to determining that the feature is not requested and in response to the selected SSB being the first or third SSB; determining a PRACH resource, which is associated with the selected SSB and indicates the feature is not requested, as the first PRACH resource in response to determining that the feature is not requested and in response to the selected SSB being the fifth or eighth SSB; determining a PRACH resource, which is associated with the selected SSB and indicates the feature is requested, as the first PRACH resource in response to determining that the feature is requested and in response to the selected SSB being the first or third SSB; and determining a PRACH resource, which is associated with the selected SSB and indicates the feature is requested, as the first PRACH resource in response to determining that the feature is requested and in response to the selected SSB being the fifth or eighth SSB.

In some embodiments, the step of determining the first PRACH resource at least partially based on the selected SSB and the determination of whether the feature is requested or not comprises at least one of: determining a PRACH resource, which is associated with the selected SSB and indicates the feature is not requested, as the first PRACH resource in response to determining that the feature is not requested and in response to the selected SSB being the first or third SSB; determining a PRACH resource, which is associated with the selected SSB and indicates the feature is not requested, as the first PRACH resource in response to determining that the feature is not requested and in response to the selected SSB being the fifth or eighth SSB; determining a PRACH resource, which is associated with the selected SSB and indicates the feature is requested, as the first PRACH resource in response to determining that the feature is requested and in response to the selected SSB being the second or fourth SSB; and determining a PRACH resource, which is associated with the selected SSB and indicates the feature is requested, as the first PRACH resource in response to determining that the feature is requested and in response to the selected SSB being the seventh or eighth SSB.

In some embodiments, the step of determining the first PRACH resource at least partially based on the selected SSB and the determination of whether the feature is requested or not comprises at least one of: determining a PRACH resource, which is associated with the selected SSB and indicates the feature is not requested, as the first PRACH resource in response to determining that the feature is not requested and in response to the selected SSB being the first or third SSB; determining a PRACH resource, which is associated with the selected SSB and indicates the feature is requested, as the first PRACH resource in response to determining that the feature is not requested and in response to the selected SSB being the sixth SSB; determining a PRACH resource, which is associated with the selected SSB and indicates the feature is requested, as the first PRACH resource in response to determining that the feature is requested and in response to the selected SSB being the second or fourth SSB; and determining a PRACH resource, which is associated with the selected SSB and indicates the feature is requested, as the first PRACH resource in response to determining that the feature is requested and in response to the selected SSB being the seventh or eighth SSB.

In some embodiments, after the step of determining whether the feature is requested or not, the method further comprises at least one of:—setting the variable “RA_TYPE” at the UE to indicate whether the feature is requested or not, wherein the variable “RA_TYPE” has a value indicating 2-stepRA, 4-stepRA, or 4-stepRA-rep based on the determination;—setting a variable different from the variable “RA_TYPE” at the UE to indicate whether its access type is a random access with the feature or not based on the determination; and—setting a variable different from the variable “RA_TYPE” at the UE to indicate whether the UE shall signal, to the network node, that the feature is requested or not based on the determination.

In some embodiments, the step of determining the first PRACH resource comprises: selecting one of multiple SSBs broadcasted by the network node at least partially based on the received configuration and one or more second measurements at the UE; determining whether the feature is requested or not at least partially based on at least one of:—the received configuration and a first measurement at the UE;—the received configuration and the one or more second measurements at the UE; and—the selected SSB; and determining the first PRACH resource at least partially based on the selected SSB and the determination of whether the feature is requested or not.

In some embodiments, the selected SSB is one of:—a first SSB that is first determined to have a measured RSRP higher than a second threshold indicated by the received configuration;—a second SSB that is first determined to have a measured RSRP higher than the second threshold or a third threshold indicated by the received configuration;—a third SSB that is first determined to have a measured RSRP higher than a fourth threshold indicated by the received configuration;—a fourth SSB having the highest measured RSRP that is higher than the second threshold;—a fifth SSB having the highest measured RSRP that is higher than the second or third threshold;—a sixth SSB having the highest measured RSRP that is higher than the fourth threshold;—a seventh SSB having the highest measured RSRP that is lower than or equal to the second threshold;—an eighth SSB having the highest measured RSRP that is lower than or equal to both of the second threshold and the third threshold;—a ninth SSB having the highest measured RSRP that is lower than or equal to the fourth threshold; and—a tenth SSB that is randomly selected and has a measured RSRP lower than or equal to the second threshold and/or the third threshold and/or the fourth threshold. In some embodiments, the second threshold is indicated by an information element (IE) “rsrp-ThresholdSSB” in the configuration, wherein the third threshold is indicated by a second IE in the configuration or jointly indicated by the IE “rsrp-ThresholdSSB” and a third IE in the configuration that indicates an offset; and wherein the fourth threshold is indicated by a fourth IE in the configuration.

In some embodiments, the step of determining whether the feature is requested or not comprises: determining whether RSRP of a downlink pathloss reference, which is measured at the UE, is higher than or equal to a first threshold indicated by the received configuration or not; and determining that the feature is not requested in response to determining that the RSRP of the downlink pathloss reference is higher than or equal to the first threshold.

In some embodiments, the step of determining whether the feature is requested or not comprises: determining whether RSRP of a downlink pathloss reference, which is measured at the UE, is higher than or equal to a first threshold indicated by the received configuration or not; and determining that the feature is requested in response to determining that the RSRP of the downlink pathloss reference is lower than the first threshold.

In some embodiments, the step of determining whether the feature is requested or not comprises: determining whether the RSRP of the selected SSB is higher than the third threshold or not; and determining that the feature is requested in response to determining that the RSRP of the selected SSB is lower than or equal to the third threshold.

In some embodiments, the step of determining whether the feature is requested or not comprises: determining whether the RSRP of the selected SSB is higher than the third threshold or not; and determining that the feature is not requested in response to determining that the RSRP of the selected SSB is higher than the third threshold.

In some embodiments, the step of determining whether the feature is requested or not comprises: determining that the feature is requested in response to determining that the selected SSB is the eighth SSB.

In some embodiments, the step of determining whether the feature is requested or not comprises: determining that the feature is not requested in response to determining that the selected SSB is the first or fourth SSB.

In some embodiments, the step of determining whether the feature is requested or not comprises: determining whether the RSRP of the selected SSB is higher than the third threshold or not; and determining that the feature is requested in response to determining that the RSRP of the selected SSB is higher than the third threshold.

In some embodiments, the step of determining whether the feature is requested or not comprises: determining whether the RSRP of the selected SSB is higher than or equal to the fourth threshold plus a repetition offset indicated by the received configuration or not; and determining that the feature is not requested in response to determining that the RSRP of the selected SSB is higher than or equal to the fourth threshold plus the repetition offset.

In some embodiments, the step of determining whether the feature is requested or not comprises: determining whether the RSRP of the selected SSB is higher than or equal to the fourth threshold plus a repetition offset indicated by the received configuration or not; and determining that the feature is requested in response to determining that the RSRP of the selected SSB is lower than the fourth threshold plus the repetition offset.

In some embodiments, the step of determining whether the feature is requested or not comprises: determining that the feature is requested in response to determining that the RSRP of the selected SSB is lower than the fourth threshold.

In some embodiments, the step of determining the first PRACH resource at least partially based on the selected SSB and the determination of whether the feature is requested or not comprises at least one of: determining a PRACH resource, which is associated with the selected SSB and indicates the feature is not requested, as the first PRACH resource in response to determining that the feature is not requested and in response to the selected SSB being the first or fourth SSB; determining a PRACH resource, which is associated with the selected SSB and indicates the feature is requested, as the first PRACH resource in response to determining that the feature is requested and in response to the selected SSB being the first or fourth SSB; determining a PRACH resource, which is associated with the selected SSB and indicates the feature is not requested, as the first PRACH resource in response to determining that the feature is not requested and in response to the selected SSB being the seventh or tenth SSB; and determining a PRACH resource, which is associated with the selected SSB and indicates the feature is requested, as the first PRACH resource in response to determining that the feature is requested and in response to the selected SSB being the seventh or tenth SSB.

In some embodiments, the step of determining the first PRACH resource at least partially based on the selected SSB and the determination of whether the feature is requested or not comprises at least one of: determining a PRACH resource, which is associated with the selected SSB and indicates the feature is not requested, as the first PRACH resource in response to determining that the feature is not requested and in response to the selected SSB being the second or fifth SSB; determining a PRACH resource, which is associated with the selected SSB and indicates the feature is requested, as the first PRACH resource in response to determining that the feature is requested and in response to the selected SSB being the second or fifth SSB; determining a PRACH resource, which is associated with the selected SSB and indicates the feature is requested, as the first PRACH resource in response to determining that the feature is requested and in response to the selected SSB being the eighth or tenth SSB.

In some embodiments, the step of determining the first PRACH resource at least partially based on the selected SSB and the determination of whether the feature is requested or not comprises at least one of: determining a PRACH resource, which is associated with the selected SSB and indicates the feature is not requested, as the first PRACH resource in response to determining that the feature is not requested and in response to the selected SSB being the first or fourth SSB; determining a PRACH resource, which is associated with the selected SSB and indicates the feature is requested, as the first PRACH resource in response to determining that the feature is requested and in response to the selected SSB being the seventh or tenth SSB.

In some embodiments, the step of determining the first PRACH resource at least partially based on the selected SSB and the determination of whether the feature is requested or not comprises at least one of: determining a PRACH resource, which is associated with the selected SSB and indicates the feature is not requested, as the first PRACH resource in response to determining that the feature is not requested and in response to the selected SSB being the third or sixth SSB; determining a PRACH resource, which is associated with the selected SSB and indicates the feature is requested, as the first PRACH resource in response to determining that the feature is requested and in response to the selected SSB being the third or sixth SSB; determining a PRACH resource, which is associated with the selected SSB and indicates the feature is requested, as the first PRACH resource in response to determining that the feature is requested and in response to the selected SSB being the ninth or tenth SSB.

In some embodiments, the step of determining the first PRACH resource at least partially based on the selected SSB and the determination of whether the feature is requested or not comprises: determining a PRACH resource, which indicates the feature is requested, as the first PRACH resource in response to determining that the UE is in a connected state with the network node and at least one pre-defined condition is met.

In some embodiments, the at least one pre-defined condition comprises at least one of:—the PRACH transmission is used for beam failure recovery (BFR);—the PRACH transmission is used for uplink synchronization;—the PRACH transmission is used for Radio Resource Control (RRC) connection re-establishment; and—the PRACH transmission is used for Scheduling Request (SR) failure.

In some embodiments, before the step of determining the first PRACH resource, the method further comprises: receiving, from the network node, an indicator for each of one or more of the at least one pre-defined condition.

In some embodiments, the step of determining the first PRACH resource at least partially based on the selected SSB and the determination of whether the feature is requested or not comprises: determining a PRACH resource, which indicates the feature is requested, as the first PRACH resource in response to determining that the timing advance (TA) for the UE is changed by a value greater than a TA threshold.

In some embodiments, the step of determining the first PRACH resource at least partially based on the selected SSB and the determination of whether the feature is requested or not comprises: determining a PRACH resource, which indicates the feature is requested, as the first PRACH resource in response to determining that a distance between the UE and the network node is longer than a distance threshold.

In some embodiments, when the feature is not MsgA repetition, the method further comprises: receiving, from the network node, a random access response (RAR) comprising an indicator indicating whether the feature is to be used or not; and transmitting, to the network node, a Msg3 with or without the feature depending on the received indicator.

According to a second aspect of the present disclosure, a user equipment (UE) is provided. The UE comprises: a processor; a memory storing instructions which, when executed by the processor, cause the processor to perform the method of any of the first aspect.

According to a third aspect of the present disclosure, a method at a network node for performing a random access procedure with a user equipment (UE) is provided. The method comprises: broadcasting or transmitting, to the UE, a configuration for physical random access channel (PRACH) transmission; receiving the PRACH transmission by using a first PRACH resource, the first PRACH resource itself indicating whether a feature is requested by the UE or not; and transmitting, to the UE, a random access response (RAR) at least partially based on whether the feature is requested by the UE or not.

In some embodiments, the first PRACH resource comprises at least one of:—a PRACH time/frequency resource; and—a PRACH preamble sequence. In some embodiments, the feature comprises at least one of:—Msg3 repetition;—MsgA repetition;—a network slice;—Non-small data transmission (Non-SDT);—a UE with reduced capability (RedCap UE);—a random access in non-terrestrial network; and—a specific service type or UE priority.

In some embodiments, the configuration comprises at least one of:—a first threshold for determining whether the feature can be requested or not;—a second threshold for both a non-Msg3-repetition-capable UE and a Msg3-repetition-capable UE to determine whether a SSB can be selected or not;—a third threshold for determining, alone or together with the second threshold, whether a SSB can be selected or not when the feature is to be requested; and—a fourth threshold for a Msg3-repetition-capable UE only to determine whether a SSB can be selected or not.

In some embodiments, the method further comprises: for each of at least one of following pre-defined conditions, broadcasting or transmitting, to the UE, an indicator to indicate that the feature can be always requested if the corresponding condition is met:—the PRACH transmission is used for beam failure recovery (BFR);—the PRACH transmission is used for uplink synchronization;—the PRACH transmission is used for Radio Resource Control (RRC) connection re-establishment; and—the PRACH transmission is used for Scheduling Request (SR) failure.

In some embodiments, when the feature is not MsgA repetition, the method further comprises: receiving, from the UE, a Msg3 with the feature enabled or disabled depending on the RAR.

According to a fourth aspect of the present disclosure, a network node is provided. The network node comprises: a processor; a memory storing instructions which, when executed by the processor, cause the processor to perform the method of any of the third aspect.

According to a fifth aspect of the present disclosure, a computer program comprising instructions is provided. The instructions, when executed by at least one processor, cause the at least one processor to carry out the method of any of the first or third aspect.

According to a sixth aspect of the present disclosure, a carrier containing the computer program of the fifth aspect is provided. The carrier is one of an electronic signal, optical signal, radio signal, or computer readable storage medium.

According to a seventh aspect of the present disclosure, a telecommunications system is provided. The telecommunications system comprises one or more UEs of the second aspect; and at least one network node of the fourth aspect.

### BRIEF DESCRIPTION OF THE DRAWINGS

FIG. 1 shows flow charts illustrating exemplary Type-1 and Type-2 RA procedures, respectively, with which a UE and gNB according to an embodiment of the present disclosure may be operable.

FIG. 2 is a diagram illustrating an exemplary one-to-one mapping between SSBs and PRACH occasions with which a UE and gNB according to an embodiment of the present disclosure may be operable.

FIG. 3 is a diagram illustrating an exemplary many-to-one mapping between SSBs and PRACH occasions with which a UE and gNB according to an embodiment of the present disclosure may be operable.

FIG. 4 to FIG. 10 are flow charts illustrating exemplary procedures for determining a PRACH resource to be used for PRACH transmission according to some embodiments of the present disclosure.

FIG. 11 is a flow chart illustrating an exemplary method at a UE for feature based PRACH transmission according to an embodiment of the present disclosure.

FIG. 12 is a flow chart illustrating an exemplary method at a network node for feature based PRACH transmission according to an embodiment of the present disclosure.

FIG. 13 schematically shows an embodiment of an arrangement which may be used in a UE or a network node according to an embodiment of the present disclosure.

FIG. 14 is a block diagram of an exemplary UE according to an embodiment of the present disclosure.

FIG. 15 is a block diagram of an exemplary network node according to an embodiment of the present disclosure.

FIG. 16 schematically illustrates a telecommunication network connected via an intermediate network to a host computer according to an embodiment of the present disclosure.

FIG. 17 is a generalized block diagram of a host computer communicating via a base station with a user equipment over a partially wireless connection according to an embodiment of the present disclosure.

FIG. 18 to FIG. 21 are flowcharts illustrating methods implemented in a communication system including a host computer, a base station and a user equipment according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as a random access procedure is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5th Generation New Radio (5G NR), etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “gNB” used herein may refer to a network node, a base station, a base transceiver station, an access point, a hot spot, a NodeB, an Evolved NodeB, a network element, or any other equivalents. Further, please note that the term “field” used herein may refer to a parameter, a coefficient, an attribute, a property, a setting, a configuration, a profile, an identifier, an indicator, one or more bits/octets, an information element, or any data by which information of interest may be indicated directly or indirectly. Further, please note that the term “aspect” used herein may refer to a field, a parameter, a coefficient, an attribute, a property, a setting, a configuration, a profile, an identifier, an indicator, one or more bits/octets, an information element, or any data of something without considering its specific value. Therefore, a first aspect having a first value may be same as a second aspect having a second value while the first value is different from the second value. For example, as will be discussed below, a first aspect “whether transform precoding is enabled or not” of a CG/DG-based PUSCH transmission may be same as a second aspect “whether transform precoding is enabled or not” of a PUSCH transmission in a Type-2 RA procedure while the first aspect may have a value of “enabled” but the second aspect may have a value of “disabled”.

Further, following 3GPP documents are incorporated herein by reference in their entireties:
3GPP TS 38.321 V16.4.0 (2021-03), 3rd Generation Partnership Project; Technical Specification Group Radio Access Network; NR; Medium Access Control (MAC) protocol specification (Release 16); and
3GPP TS 38.331 V16.4.1 (2021-03), 3rd Generation Partnership Project; Technical Specification Group Radio Access Network; NR; Radio Resource Control (RRC) protocol specification (Release 16).

When a UE wants to access to a 5G NR network, it has to synchronize in downlink as well as in uplink. Downlink synchronization may be obtained after successfully decoding Synchronous Signal and PBCH block (SSB). In order to establish uplink synchronization and an RRC connection, the UE has to perform a random access procedure.

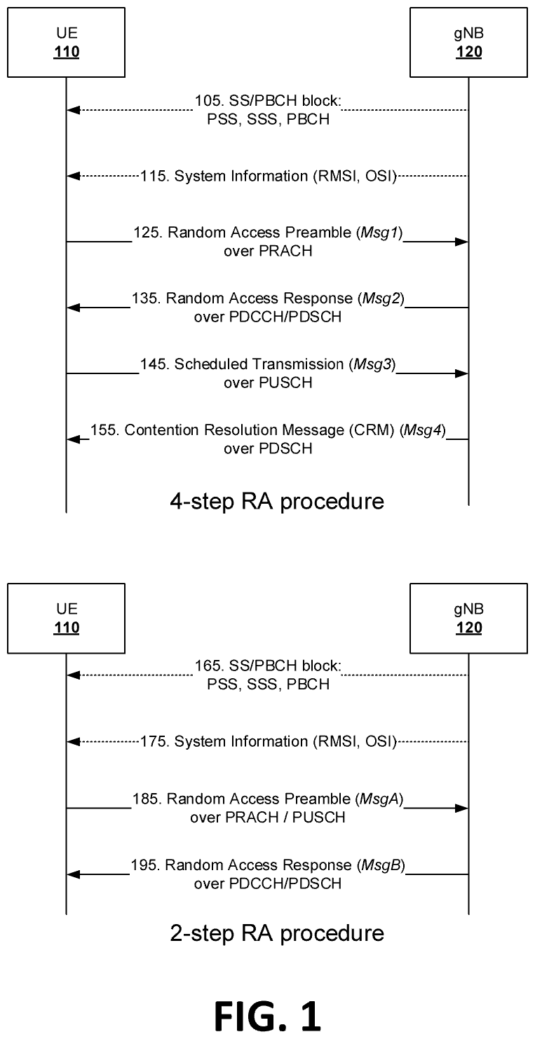

FIG. 1 shows flow charts illustrating exemplary Type-1 and Type-2 RA procedures, respectively, with which a UE and gNB according to an embodiment of the present disclosure may be operable. As shown in FIG. 1, there are two types of RA procedures:
Type-1 RA procedure, also known as 4-step RACH, or 4-step RA procedure; and
Type-2 RA procedure, also known as 2-step RACH, or 2-step RA procedure.

Further, RA procedures may also be classified into Contention Based Random Access (CBRA) or Non Contention or Contention Free Random Access (CFRA) depending on how its preamble is selected. In the contention based RA procedure, a UE may select a preamble randomly from a pool of preambles shared with other UEs. This means that the UE has a potential risks of selecting a same preamble as another UE and subsequently may experience conflict or contention. The gNB may use a contention resolution mechanism to handle this type of access requests. In this procedure, the result is random and not all RA succeeds.

Referring to the top flow chart of FIG. 1, an exemplary 4-step RA procedure may comprise four steps 125 to 155 for a UE 110 to access a gNB 120 after necessary system information, which is broadcasted by the gNB 120, is obtained at the steps 105 and 115.

At step 105, the UE 110 may receive a Master Information Block (MIB) from the gNB 120 by detecting an SSB which may comprise a Primary Synchronous Signal (PSS), a Secondary Synchronous Signal (SSS), and a PBCH carrying the MIB. Upon successful reception and decoding of the MIB, the UE 110 may determine time/frequency positions for monitoring Remaining Minimum System Information (RMSI) or System Information Block 1 (SIB1) broadcasted by the gNB 120, for example, by a pdcch-ConfigSIB1 information element (IE) comprised in the MIB.

At step 115, the UE 110 may receive the RMSI and Other System Information (OSI) from the gNB 120. For example, the UE 110 may receive and decode the RMSI (SIB1) based on the information determined at the step 105 to determine time/frequency positions for monitoring OSI broadcasted by the gNB 120, for example, by a searchSpaceOtherSystemInformation IE comprised in the SIB1. Further, the UE 110 may also obtain any parameters necessary for the 4-step RA procedure. For example, the UE 110 may determine a set of preambles by a RACH-ConfigCommon IE which can be used later during the 4-step RA procedure.

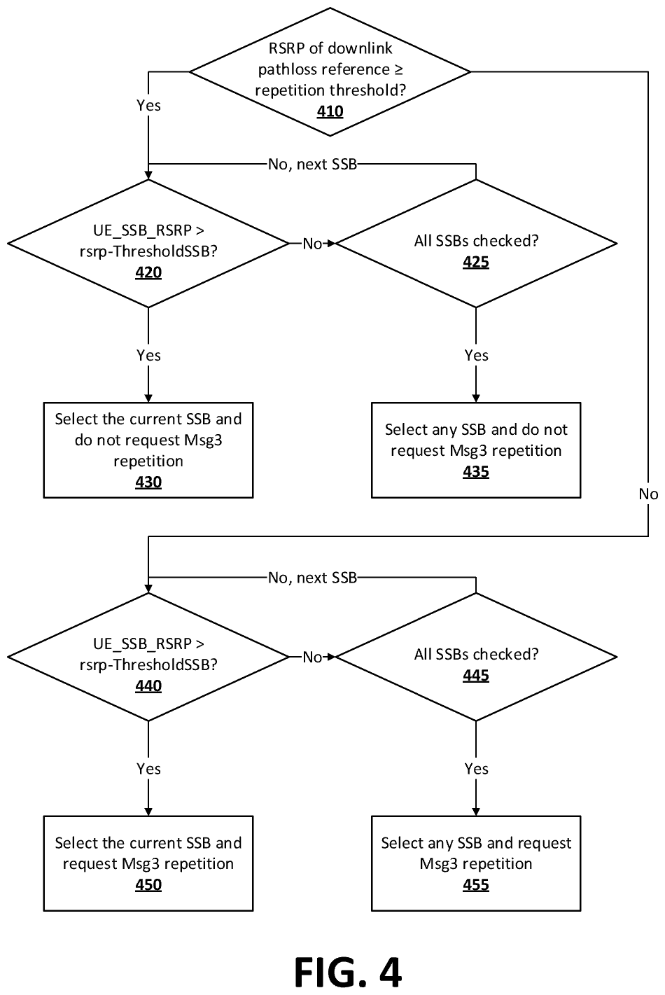

At step 125, the UE 110 may transmit a preamble which is selected from the set of preambles determined at the step 115 to the gNB 120 in Msg1. The selection of the preamble may be performed in a manner described with reference to FIG. 4 to FIG. 10 or in any other manner, for example, in a random manner.

At step 135, upon reception of Msg1, the gNB 120 may select or otherwise determine a Temporary Cell-Radio Network Temporary Identifier (TC-RNTI) and uplink and downlink scheduling resources for the UE 110. Then, the gNB 120 may transmit an RA response (RAR or Msg2) over PDCCH/PDSCH. The response may contain the RA-preamble identifier, timing alignment information, initial uplink grant, and the TC-RNTI. One PDSCH may carry RA responses to multiple UEs. On the other hand, after transmitting the preamble, the UE 110 may monitor the PDCCH and wait for the RAR within an RA response window:
If the UE 110 receives a response containing an RA-preamble identifier which is the same as the identifier contained in the transmitted RA preamble, the response is successful. The UE 110 may then transmit uplink scheduling information later.
If the UE 110 does not receive a response within the RA response window or fails to verify the response, the response fails. In this case, if the number of RA attempts is less than the upper limit (e.g., 10), the UE 110 may retry the RA procedure. Otherwise, the RA procedure fails.

Further, the UE 110 may use the timing alignment information comprised in the RAR to adjust the timing of any subsequent PUSCH transmission, allowing PUSCH to be received at the gNB 120 with a timing accuracy within the cyclic prefix (CP). Without this timing advance functionality, a very large CP would be needed in order to be able to demodulate and detect PUSCH, unless the system is applied in a cell with very small distance between the UE 110 and the gNB 120. Since NR will also support larger cells, there is a need for providing a timing advance to the UE 110.

At step 145, the UE 110 may transmit uplink scheduling information (Msg3) over the PUSCH. The signaling messages and information transmitted by the UE 110 may vary across different RA scenarios and some examples are listed below:
Initial RRC connection setup: The RRCSetupRequest message (carrying NAS UE_ID) is transmitted over the common control channel (CCCH) in TM at the Radio Link Control (RLC) layer. The message is not segmented.
RRC connection reestablishment: The RRC Reestablishment Request message (not carrying the NAS message) is transmitted over the CCCH in TM at the RLC layer. The message is not segmented.
Handover: Contention-based RA, instead of non-contention-based RA, is triggered if the UE 110 accesses the target cell and no dedicated preambles are available during a handover. The RRC Handover Confirm message and C-RNTI are transmitted over the dedicated control channel (DCCH). If required, a buffer status report (BSR) may also be carried.
Other scenarios: At least the C-RNTI of the UE 110 may be transmitted.

At step 155, after transmitting the Msg3, a contention resolution timer may be started at the UE 110. The gNB 120 may assist the UE 110 in contention resolution using the C-RNTI on the PDCCH or using the UE Contention Resolution Identity IE on the PDSCH.

The UE 110 may keep monitoring the PDCCH before the timer expires and considers the contention resolution successful and stops the timer if either of the following conditions is met:
The UE 110 obtains the C-RNTI over the PDCCH.
The UE 110 obtains the temporary C-RNTI over the PDCCH and the MAC PDU is successfully decoded. Specifically, the UE Contention Resolution Identity IE received over the PDSCH is the same as that carried in Msg3 sent by the UE.

If the contention resolution timer expires, the UE 110 may consider the contention resolution failed. Then, the UE 110 may perform the RA procedure again if the number of RA attempts has not reached the upper limit. If the number of RA attempts has reached its upper limit, the RA procedure fails.

In non-contention based Random Access, the preamble may be pre-allocated by the gNB 120 and such preambles may be known as dedicated random access preamble. The dedicated preamble may be provided to the UE 110 either via RRC signalling (e.g., allocated preamble(s) can be specified within an RRC message) or PHY Layer signalling (e.g., DCI on the PDCCH). Therefore, there is no preamble conflict. When dedicated resources are insufficient, the gNB 120 may instruct UEs to initiate contention-based RA.

The gNB 120 may allocate an RA preamble to the UE 110 and sent it using an RRC message or DCI signaling. Some scenarios are listed below:
Handover: The MobilityControlInfo IE sent by the source gNB may carry the allocated preamble;
DL Data Arrival: When downlink data arrives at the gNB 120, the gNB 120 may instruct the UE 110 to initiate an RA procedure through DCI over PDCCH, which carries the allocated preamble;
Non-Standalone (NSA) networking: When NR cells are added in NSA, the gNB 120 may instruct the UE 110 to initiate an RA procedure through the PDCCH, which carries the allocated preamble.

Referring to the bottom flow chart of FIG. 1, an exemplary 2-step RA procedure may comprise two steps 185 and 195 for a UE 110 to access a gNB 120 after necessary system information, which is broadcasted by the gNB 120, is obtained at the steps 165 and 175.

Similar to the step 105, at step 165, the UE 110 may receive a Master Information Block (MIB) from the gNB 120 by detecting an SSB. Upon successful reception and decoding of the MIB, the UE 110 may determine time/frequency positions for monitoring Remaining Minimum System Information (RMSI) or System Information Block 1 (SIB1) broadcasted by the gNB 120.

Similar to the step 115, at step 175, the UE 110 may receive the RMSI and Other System Information (OSI) from the gNB 120. For example, the UE 110 may receive and decode the RMSI (SIB1) based on the information determined at the step 105 to determine time/frequency positions for monitoring OSI broadcasted by the gNB 120, for example, by a searchSpaceOtherSystemInformation IE comprised in the SIB1. Further, the UE 110 may also obtain any parameters necessary for the 2-step RA procedure. For example, the UE 110 may determine available time/frequency occasions for PRACH by a msgA-ConfigCommon IE comprised in the SIB1, which can be used later during the 2-step RA procedure.

Similar to the step 125, at the step 185, the UE 110 may transmit to the gNB 120 an RA preamble (MsgA), which is pre-allocated by the gNB 120, together with higher layer data such as an RRC connection request possibly with some small additional payload on PUSCH. In such a case, no confliction with other UEs will happen.

Similar to the step 135, the gNB 120 may transmit an RA response (MsgB) to the UE 110. Since no conflict with other UEs will occur, and the steps for contention resolving (e.g., Msg3 and Msg4 in the 4-step RA procedure) may be omitted.

In the handover scenario, the RA response may contain the timing alignment information and initial uplink grant. In the DL data arrival scenario, when downlink data arrives at the gNB 120, the RA response may contain the timing alignment information and RA preamble identifier (RAPID). In the NSA networking scenario, when NR cells are added in NSA, the RA response may contain the timing alignment information and RA preamble identifier (RAPID).

Please note that although FIG. 1 shows a 4-step contention-based RA procedure (or CBRA of Type 1) and a 2-step non-contention-based RA procedure (or CFRA of Type 2), the present disclosure is not limited thereto. In other embodiments, other RA procedures may also be applicable, such as, a 4-step non-contention-based RA procedure (or CFRA of Type 1) and/or a 2-step contention-based RA procedure (or CBRA of Type 2).

In 3GPP RAN #90e, the following objectives have been approved for NR coverage enhancement work item in NR Rel-17 for PUSCH:
Specification of PUSCH enhancements [RAN1, RAN4]
   Specify the following mechanisms for enhancements on PUSCH repetition type A [RAN1]
      Increasing the maximum number of repetitions up to a number to be determined during the course of the work.
      The number of repetitions counted on the basis of available UL slots.
   Specify mechanism(s) to support transport block (TB) processing over multi-slot PUSCH [RAN1]
      TB size (TBS) determined based on multiple slots and transmitted over multiple slots.
   Specify mechanism(s) to enable joint channel estimation [RAN1, RAN4]
      Mechanism(s) to enable joint channel estimation over multiple PUSCH transmissions, based on the conditions to keep power consistency and phase continuity to be investigated and specified if necessary by RAN4 [RAN1, RAN4]
         Potential optimization of DMRS location/granularity in time domain is not precluded
      Inter-slot frequency hopping with inter-slot bundling to enable joint channel estimation [RAN1]
Specification of PUCCH enhancements [RAN1, RAN4]
   Specify signaling mechanism to support dynamic PUCCH repetition factor indication [RAN1]
   Specify mechanism to support DMRS bundling across PUCCH repetitions [RAN1, RAN4]
Specify mechanism(s) to support Type A PUSCH repetitions for Msg3 [RAN1] In some embodiments of the present disclosure, the Type A PUSCH repetitions for Msg3 will be described.

As already described with reference to FIG. 1, two types of random access procedures are supported in NR till release 16, where a MsgA PUSCH or a Msg3 PUSCH transmissions is used for transmission of RRC setup request message in 2-step RACH RA type and 4-step RA type, respectively. Neither Msg3 PUSCH nor MsgA PUSCH can be repeated in NR up to Rel-16.

In both 4-step RACH and 2-step RACH, PRACH resources may be selected based on the SSB selection and a SSB to RACH occasion (RO)/preamble mapping. Detailed procedures of PRACH resource selection may be found in section 5.1.2 and 5.1.2a of 3GPP TS 38.321 for 4-step RACH and 2-step RACH, respectively.

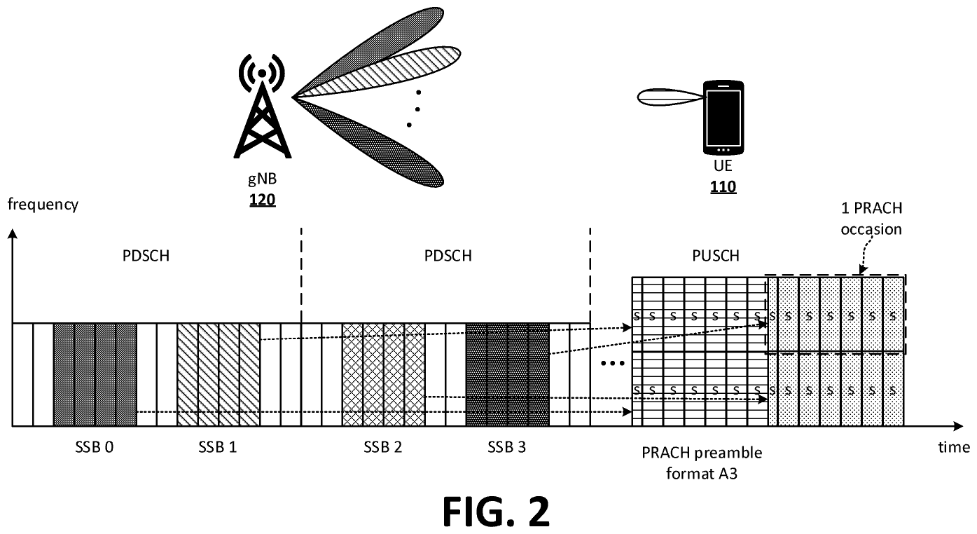

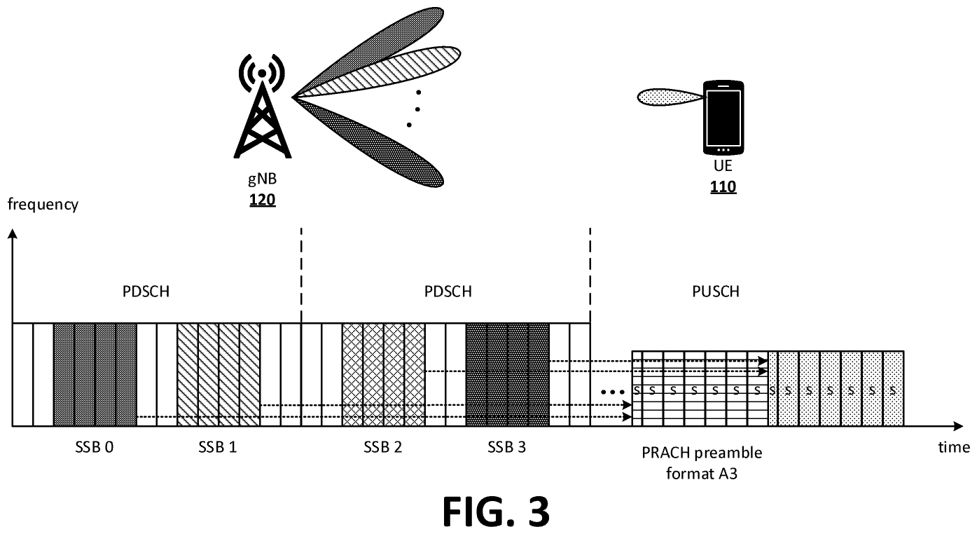

The mapping between SSB and PRACH may be one-to-one, one-to-many, and many-to-one in a predetermined order specified in standard. For example, FIG. 2 and FIG. 3 show exemplary one-to-one and many-to-one mapping between SSB and PRACH occasions, respectively.

When a UE (e.g., the UE 110) determines a good enough SSB beam with Synchronous Signal-Reference Signal Received Power (SS-RSRP) above an RSRP threshold (e.g., rsrp-ThresholdSSB), a preamble in the set of one or more preambles in a PRACH occasion mapped to this SSB may be selected for the random access, then when the gNB (e.g., the gNB 120) detects the preamble, the determined SSB beam for this UE may be known indirectly to some extent so that determined beam can be used for transmitting signals to or receiving signals from this UE.

FIG. 2 shows four SSBs (e.g., SSB 0, SSB1, SSB2, and SSB3) broadcasted by the gNB 120 and four PRACH occasions for the UE 110 to transmit its PRACH for its random access procedure. As shown in FIG. 2, there is one-to-one mapping between the four SSBs and four PRACH occasions, which is indicated by the arrows. After the UE 110 detects the four SSBs and select one of them, for example, the SSB with the highest SS-RSRP (e.g., SSB 1), the UE 110 may choose the PRACH occasion mapped to the SSB 1 for its PRACH transmission. By detecting the PRACH received over the PRACH occasion, the gNB 120 may determine which of the SSBs is selected by the UE 110 (i.e., SSB 1) and corresponding radio resources may be assigned accordingly based on this selection.

FIG. 3 shows four SSBs (e.g., SSB 0, SSB1, SSB2, and SSB3) broadcasted by the gNB 120 and two PRACH occasions for the UE 110 to transmit its PRACH for its random access procedure. As shown in FIG. 3, there is many-to-one mapping between the four SSBs and two PRACH occasions, which is indicated by the arrows. After the UE 110 detects the four SSBs and select one of them, for example, the SSB with the highest SS-RSRP (e.g., SSB 3), the UE 110 may choose the PRACH occasion mapped to the SSB 3 for its PRACH transmission. By detecting the PRACH received over the PRACH occasion, the gNB 120 may determine which ones of the SSBs are selected by the UE 110 (i.e., SSB2 or SSB3) and corresponding radio resources may be assigned accordingly based on this selection.

Please note that the present disclosure is not limited thereto. In some other embodiments, a different number of SSBs and/or a different number of PRACH occasions and/or a different mapping may be provided. Further, although it looks like, in FIG. 2 and FIG. 3, the SSBs and the PRACH occasions are located within a same frequency band, they actually may be not. In some embodiments, they may be located within different frequency bands, for example, different subcarriers, different resource blocks (RBs), different bandwidth parts (BWPs), or even different carriers.

During the discussions in the meetings from 3GPP RAN1 #104-e, the first meeting of the NR coverage enhancement work item in Rel-17, to 3GPP RAN1 #105-e, following agreements have been made regarding the Msg3 repetition criteria:
UE determines a separate PRACH resource (separate preamble and/or separate PRACH occasions) based at least on RSRP of the downlink pathloss reference and the RSRP threshold;
Based on the PRACH resource on which a PRACH is detected, gNB is aware of whether a Msg3 repetition can be enabled for the UE sending this PRACH.

### Agreement: For Msg3 PUSCH Repetition, Support the Following Modified Option 2-1.

Option 2-1: For UE requested Msg3 PUSCH repetition with gNB indicating the number of repetitions,
   A UE can request Msg3 PUSCH repetition via separate PRACH resources (FFS details, e.g., separate PRACH occasion or separate PRACH preamble in case of shared PRACH occasions after SSB association, etc.).
      Whether a UE would request is based on some conditions, e.g., measured SS-RSRP threshold, which may or may not have spec impact.
   If Msg3 PUSCH repetition is requested by UE, gNB decides whether to schedule Msg3 PUSCH repetition or not. If scheduled, gNB decides the number of repetitions for Msg3 PUSCH 3 (re)-transmission.
   For further study (FFS) the UE capability of supporting Msg3 PUSCH repetition can be reported after initial access procedure as usual
   FFS details if any.

Agreement: A UE requests Msg3 PUSCH repetition at least when the RSRP of the downlink pathloss reference is lower than an RSRP threshold.
FFS the determination of the RSRP threshold.

### Agreement:

For requesting Msg3 PUSCH repetition, support the following:
   Use separate preamble with shared RO configured by the same PRACH configuration index with legacy UEs.
      FFS whether to introduce a PRACH mask to indicate a sub-set of ROs associated with a same SSB index within an SSB-RO mapping cycle for requesting Msg3 repetition for a UE.
      FFS definition of shared RO (e.g., whether the shared RO can be an RO with preamble(s) for 4-step RACH only or with preambles for both 4-step RACH and 2-step RACH).
   FFS whether or not to additionally support one (& only one) more option:
      E.g., option 2: Use separate RO configured by a separate PRACH configuration index from legacy UEs
      E.g., Option 3: Use separate RO, which include
         the separate RO configured by a separate RACH configuration index from legacy UE, and
         the remaining RO (if any) configured, by the same PRACH configuration index with legacy UEs, that cannot be used by legacy rules for PRACH transmission.

As discussed above, it has been agreed that whether a UE shall signal that msg3 repetitions are needed (either by means of random access opportunity, RACH occasion, selection, or random access preamble selection) is decided based at least on an RSRP threshold. This is straightforward as an RSRP threshold is also utilized when selecting between 4-step random access and 2-step random access where 2-step RACH is only selected if the UE is in good coverage, which implies higher RSRP with respect to the serving cell, the UE shall utilize 2-step random access. What is not straightforward is the fact that there are several thresholds used for random access selection and the interaction between these thresholds creates problems if the conditions are not designed carefully.

It is for instance not clear whether the PRACH resource selection for msg3 repetition condition should be evaluated before or after the SSB selection. Since the SSB selection is based on RSRP with a specific SSB and the PRACH resource selection for msg3 repetition condition is based on RSRP of downlink pathloss reference, this could easily create combinations that can cause erroneous selection of repetitions and SSB. Furthermore, the selection design should be such that legacy devices (devices that cannot do msg3 repetitions) that might co-exist and read the same random access configuration (except the msg3 repetitions PRACH resource configuration) should be able to access without any issues.

Further, for the connected mode, random access is used for several purposes, such as for Beam Failure Recovery (BFR), re-gaining UL synch etc. In this case there can be reasons for signaling that msg3 repetitions without checking the rsrp-Threshold.

Therefore, some embodiments of the present disclosure provide methods on how to design the random access and SSB selection conditions for selecting correct resources for requesting msg3 repetition. With these embodiments, effective selection of SSB and PRACH resources in a network when Msg3 repetition is enabled may be achieved, so that coverage limited UEs can be improved with good coverage via quick Msg3 repetition while legacy UE is not affected.

Some embodiments of the present disclosure deal with selection of SSB and preamble resources for msg3 repetitions. Please note that following parameters and nomenclature may be used in some embodiments of the present disclosure:
rsrp-ThresholdSSB may denote the legacy threshold to select an SSB for PRACH resource selection as defined in 3GPP TS 38.321;
UE_SSB_RSRP may denote the SS-RSRP measured by a UE on an SSB;
rsrp-ThresholdSSB-Repetitions may denote the RSRP threshold for SSB selection when the PRACH resource for requesting or indicating msg3 repetition is selected; and
Repetition-capable UEs may refer to UEs that can at least perform Msg3 repetitions.

Further, in some embodiments of the present disclosure, PRACH resource may be the PRACH time frequency resources and/or PRACH preamble sequences. Further, in some embodiments of the present disclosure, the “Msg3 repetition PRACH resource selection” may refer to the PRACH resource selection based on the conditions on whether a PRACH resource used for requesting/indicating that Msg3 repetition should be selected. Further, in some embodiments of the present disclosure, “Msg3 repetition PRACH resource” may be the PRACH resource separately configured for UE to request or indicate Msg3 repetition.

Further, in some embodiments of the present disclosure, the “SSB selection” may refer to the SSB selection for further PRACH resource selection as PRACH resources are always associated to SSBs.

In some embodiments of the present disclosure, the SSB selection and whether Msg3 repetition is requested or not can be applied in one or more of the following ways:
Option 1: The SSB selection is applied before whether the Msg3 repetition is requested or not is determined,
Option 2: The SSB selection is applied after whether the Msg3 repetition is requested or not is determined.

Option 1 means that SSB is selected first in the same way as legacy procedure for UEs not supporting msg3 repetition, and when the SSB is selected, the SSB will have corresponding 2 sets of PRACH resources, one is legacy PRACH resource not for requesting msg3 repetition, another set is separate PRACH resource for requesting msg3 repetition. Which set of PRACH resource is selected will be up to msg3 repetition PRACH resource selection conditions. This method may have less impact on 3GPP specification since msg3 repetition conditions are checked after SSB selection.

Option 2 means that whether msg3 repetition is requested or not is determined first. E.g. when a set of PRACH resources for requesting msg3 repetition is selected based on RSRP criteria, the SSB selection will be applied after that in a similar way as the SSB selection procedure for determining a PRACH resource in NR Rel-16. With this method, whether the msg3 repetition is requested or not does not depend on the SSB selection.

Please note that although a specific manner for selecting SSB (i.e., selecting an SSB that is first identified or determined to meet the condition) is shown in the figures and described below, the present disclosure is not limited thereto. In some other embodiments, an SSB with the best SS-RSRP may be selected. In some yet other embodiments, an SSB may be selected randomly from all SSBs that meet the condition or simply all the SSBs. In some further embodiments, an SSB may be selected in any appropriate manner, e.g., a combination of the manners described above.

Next, some embodiments where SSB selection is performed after whether msg3 repetition is requested or not is determined will be described with reference to FIG. 4 through FIG. 6. In these embodiments, the SSB selection may be performed after whether Msg3 repetition is requested or not is determined.

As shown in FIG. 4, the comparison of RSRP measurement of downlink pathloss reference is first performed at step 410 for determining whether Msg3 repetition is requested or not, and then the SSB selection may be made at steps 420 or 440 depending on the result of the step 410.

This embodiment may enable less specification change but may not enable much flexibility.

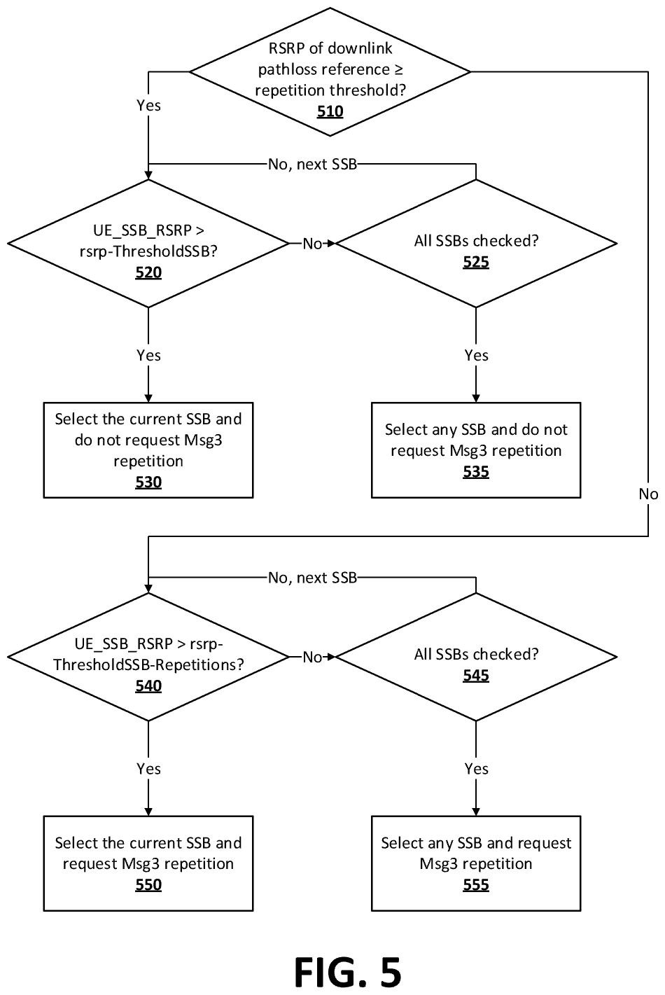

As shown in FIG. 5, a separate threshold for SSB selection (e.g., rsrp-ThresholdSSB-Repetitions) specifically for repetitions may be introduced, or an offset to rsrp-ThresholdSSB may be signaled (repetitionOffset). This threshold may be only compared if the UE 110 has determined that Msg3 repetition is to be requested. This scheme can for instance enable more flexibility as the threshold for SSB selection can be selected differently for the UEs that have selected PRACH resource for msg3 repetition indication. This can for instance allow the configuration to be such that there are 4 different combinations with decreasing RSRP:
1. Selected SSB and do not signal msg3 repetitions (530).
2. Selected any SSB and do not signal msg3 repetitions (535).
3. Selected SSB and signaling msg3 repetitions (550).
4. Selected any SSB and signaling msg3 repetitions (555).

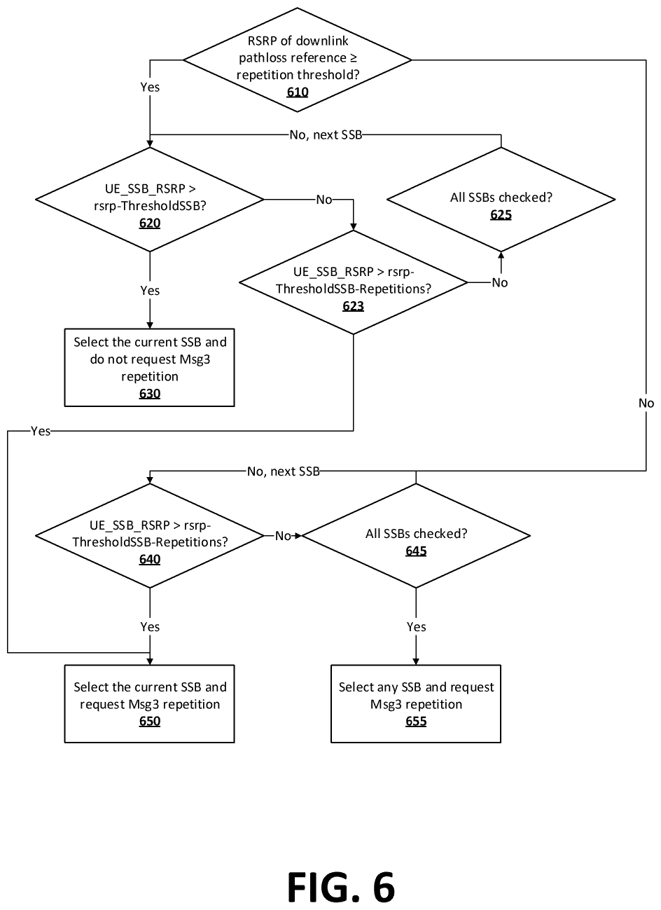

As variation on the above embodiments, if no suitable SSB is found when the UE has previously determined that it shall not select PRACH resource for msg3 repetition indication, the UE 110 can be configured to switch to select PRACH resource for msg3 repetition indication and select the SSB anyways. This can be seen in FIG. 6. This allows for 3 different combinations with decreasing RSRP:
1. Selected SSB and do not signal msg3 repetitions (630).
2. Selected SSB and signaling msg3 repetitions (650).
3. Selected any SSB and signaling msg3 repetitions (655).

Further, the above embodiments may for instance be done by introducing a variable indicating that the random access type is of type random access with msg3 repetitions. Alternatively, the above embodiments may for instance be done by introducing a variable that sets that the UE shall signal msg3 repetitions, named repetitionType where the possible values can be noRepetitions and repetitions. Alternatively, the legacy variable RA_TYPE that indicates whether 4-step or 2-step random access is performed may be extended to have the values RA_TYPE={2-stepRA, 4-stepRA, 4-stepRA-rep}.

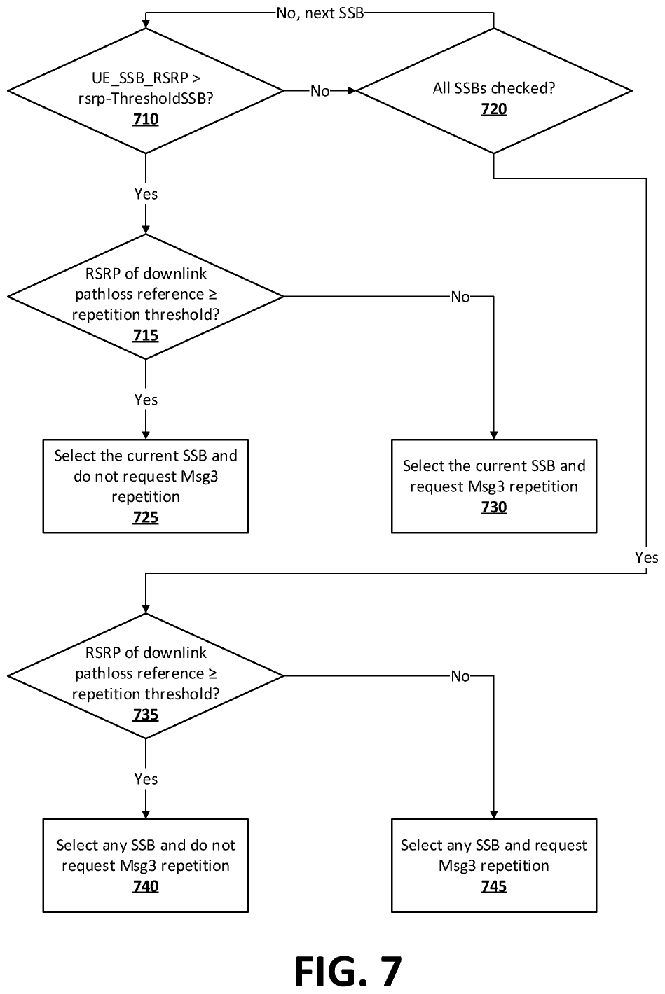

Next, some embodiments where SSB selection is performed before whether msg3 repetition is requested or not is determined will be described with reference to FIG. 7 through FIG. 10. In these embodiments, the SSB selection may be performed before whether Msg3 repetition is requested or not is determined.

As shown in FIG. 7, the SSB selection may be performed at steps 710/720 before the repetition condition is checked at steps 715/735. This means that the UE will first compare UE_SSB_RSRP>rsrp-ThresholdSSB to select the SSB, and then will compare the downlink pathloss reference to determine whether the UE 110 shall select the PRACH resources to determine whether to signal msg3 repetitions or not.

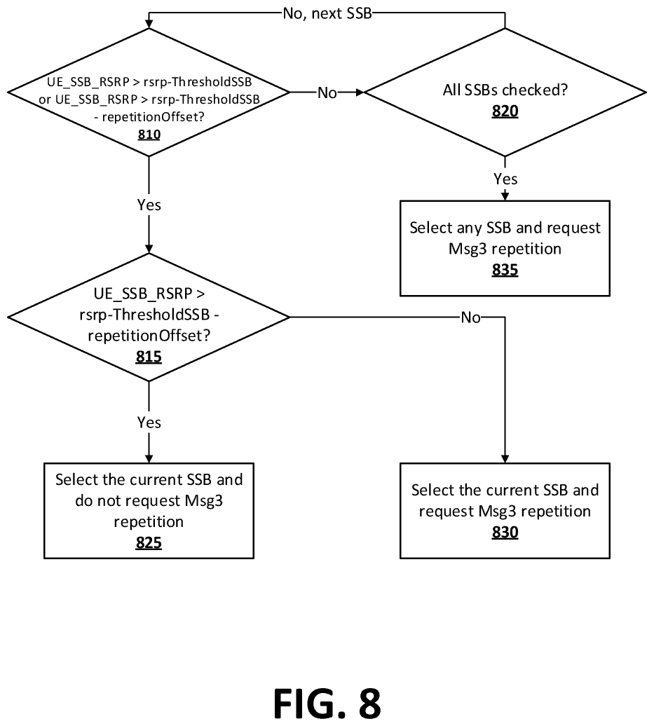

In some embodiments, the SSB selection may be done by combining the SSB selection with a repetition condition for the UE 110 to determine whether a UE shall select an SSB. The condition for selecting an SSB can be based on 1) legacy UE_SSB_RSRP>rsrp-ThresholdSSB (RSRP_UE is higher than the SSB threshold) AND 2) repetition condition. An example decision tree for this embodiment may be seen in FIG. 8. This allows for efficient selection of the SSB and whether PRACH resources shall be selected to signal msg3 repetitions, that could for instance prevent the need to lock the UE in to a specific random access type in the beginning of the random access procedure.

In some embodiments, the repetition condition may be expressed as an offset from the rsrp-ThresholdSSB. This means that in addition to the rsrp-ThresholdSSB, an offset from the rsrp-ThresholdSSB may be introduced. This means that the repetition condition for selecting an SSB may be UE_SSB_RSRP>rsrp-ThresholdSSB—repetitionOffset.

In some embodiments, the repetition condition may be based on the pathloss with the serving cell.

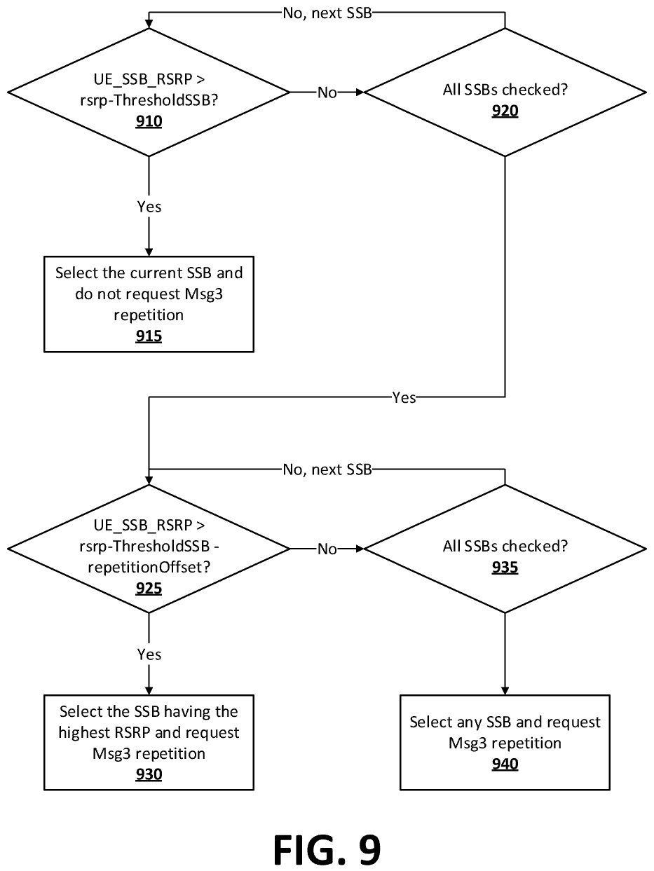

In some embodiments, the UE 110 may first check whether any SSB can be selected without a repetition condition and if no SSB can be selected, it may then check the repetition condition, where the repetition condition can be as above. The decision tree for this may be seen in FIG. 9. This for instance allows the network configure the thresholds so that a UE will not select an SSB without sufficient coverage.

This can for instance be implemented by the following text proposal (TP) (similar to FIG. 8):

5.1.2 Random Access Resource selection
1> else (i.e. for the contention-based Random Access preamble selection):
   2> if at least one of the SSBs with SS-RSRP above rsrp-ThresholdSSB or if repetitionOffset is configured SS-RSRP is above rsrp-Threshold-repetitionOffset is available:
      3> select an SSB with SS-RSRP above rsrp-ThresholdSSB or if repetitionOffset is configured SS-RSRP is above rsrp-Threshold-repetitionOffset.
   2> else:
      3> select any SSB.
   2> if the RA_TYPE is switched from 2-stepR4 to 4-stepR4:
      3> if a Random Access Preambles group was selected during the current Random Access procedure:
         4> select the same group of Random Access Preambles as was selected for the 2-step RA type.
      3> else:
         4> if Random Access Preambles group B is configured; and
         4> if the transport block size of the MSGA payload configured in the rach-ConfigDedicated corresponds to the transport block size of the MSGA payload associated with Random Access Preambles group B:
         5> select the Random Access Preambles group B.
         4> else:
         5> select the Random Access Preambles group A.

### OR by the Following (Similar to FIG. 9):

5.1.2 Random Access Resource selection
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else if repetitionOffset is configured at least one of the SSBs with SS-RSRP above rsrp-ThresoldSSB—repetitionOffset is available:
      3> select an SSB with SS-RSRP above rsrp-ThresholdSSB-repetitionOffset.
   2> else:
      3> select any SSB.
   2> if the RA_TYPE is switched from 2-stepR4 to 4-stepR4:
      3> if a Random Access Preambles group was selected during the current Random Access procedure:
         4> select the same group of Random Access Preambles as was selected for the 2-step RA type.
      3> else:
         4> if Random Access Preambles group B is configured; and
         4> if the transport block size of the MSGA payload configured in the rach-ConfigDedicated corresponds to the transport block size of the MSGA payload associated with Random Access Preambles group B:
         5> select the Random Access Preambles group B. 4> else:
         5> select the Random Access Preambles group A.
   2> if repetitionOffset is configured:
      3> if SS-RSRP is smaller than rsrp-ThresholdSSB-repetitionOffset:
         4> select the random access resources associated with signaling msg3 repetitions.
      3> else:
         4> select the random access associated with the already selected Random access preambles group.

Further, in some embodiments, a separate threshold to select an SSB may be introduced for msg3-repetition-capable UEs requesting msg3 repetition via separate PRACH resource.

This means that the repetition-capable UE may first check a separate SSB-selection threshold, similar to rsrp-ThresholdSSB to select an SSB, and will then further check whether repetitions shall be performed or not once the SSB has been selected.

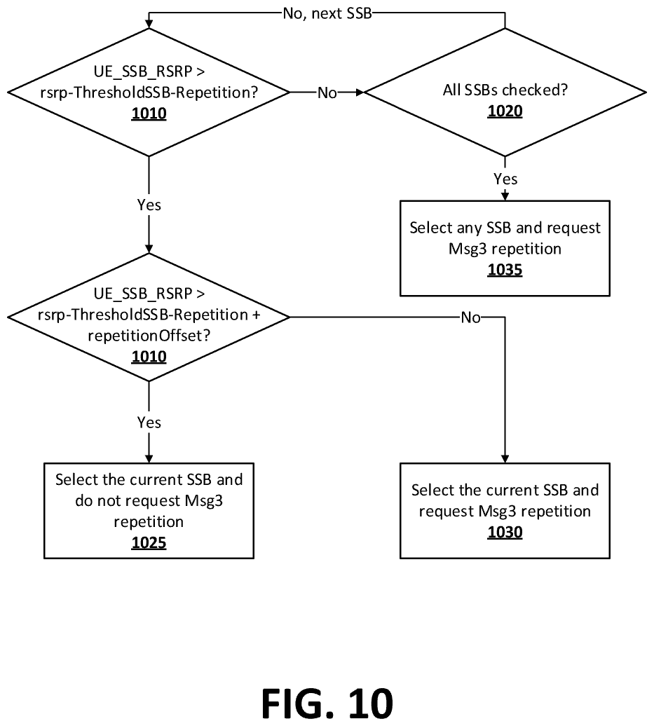

The decision tree can be seen in FIG. 10. This can be implemented as having two separate thresholds, or one threshold with an offset to it. In FIG. 10, the threshold rsrp-ThresholdSSB-Repetitions+repetitionOffset at step 1010 can thus be implemented as rsrp-ThresholdSSB-Repetitions+repetitionOffset=rsrp-Repetition-Threshold. This allows the network to configure a random access configuration used for msg3 repetitions to be relatively independent of the legacy RACH configuration.

This can be implemented by the following TP:

### This can be Implemented by the Following TP:

### 5.1.2 Random Access Resource Selection

1> else (i.e. for the contention-based Random Access preamble selection):
   2> if rsrp-ThresholdSSB-Repetitions is configured and if at least one of the SSBs with SS-RSRP above rsrp-ThresholdSSB-Repetitions is available:
      3> select an SSB with SS-RSRP above rsrp-ThresholdSSB-Repetitions.
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> if the RA TYPE is switched from 2-stepRA to 4-stepR4:
      3> if a Random Access Preambles group was selected during the current Random Access procedure:
         4> select the same group of Random Access Preambles as was selected for the 2-step RA type.
      3> else:
         4> if Random Access Preambles group B is configured; and
         4> if the transport block size of the MSGA payload configured in the rach-ConfigDedicated corresponds to the transport block size of the MSGA payload associated with Random Access Preambles group B:
         5> select the Random Access Preambles group B.
         4> else:
         5> select the Random Access Preambles group A.
   2> if rsrp-ThresholdSSB-Repetitions is configured:
      3> if SS-RSRP is smaller than rsrp-ThresholdSSB-Repetitions+rsrp-repetitionOffset:
         4> select the random access resources associated with signaling msg3 repetitions.
      3> else:
         4> select the random access associated with the already selected Random access preambles group.

In some embodiments, there can be in certain conditions (e.g. for connected mode) where the UE shall always select the resources for msg3 repetitions (when msg3 repetition is supported by the UE).

In some embodiments, the certain conditions may be one or more of the following:
The RA is used for Beam Failure Recovery (BFR);
The RA is used when UE has lost uplink synchronization;
The RA is used with RRC connection re-establishment; and
The RA is used for Scheduling Request failure.

The above allows a UE that might for instance be in momentary bad coverage to perform msg3 repetitions so that it can stay in connected mode without having to perform any of the time consuming and/or power consuming procedures that might follow if the procedure fails. There can for instance be a configuration for each procedure whether the UE shall ignore the RSRP threshold and always select the resources for msg3 repetitions.

In some embodiments, on top of the RSRP threshold condition for msg3 repetition PRACH resource selection, one or more of the following conditions can be used:
Changes of timing advance
   E.g. when TA is changing quite large relative to last TA compared to a TA change threshold value, a msg3 repetition PRACH resource can be selected. This makes sense in a highly mobile scenario, such as in Non-Terrestrial Network (NTN) where the TA is expected to change rapidly.
The distance from the UE to the gNB being above a threshold.
   This can for instance be useful for satellite communication networks where position can be readily calculated.

Further, although some embodiments are described above in the context of Msg3 repetition, the present disclosure is not limited thereto. In fact, a feature other than Msg3 repetition may also be requested via the mechanism proposed above. In some embodiments, the feature may comprises at least one of: Msg3 repetition, MsgA repetition, a network slice, Non-small data transmission (Non-SDT), a UE with reduced capability (RedCap UE), a random access in non-terrestrial network, and a specific service type or UE priority.

For example, some of the above embodiments may also applicable to the feature “MsgA repetition”. To be specific, when the RSRP for DL pathloss reference is lower than a repetition threshold, the UE 110 may select PRACH resource (e.g., a specific PRACH preamble and/or specific PRACH occasion) for its PRACH transmission, and upon detection of the PRACH transmission over the selected PRACH resource, the gNB 120 may determine that the UE 110 is requesting for MsgA repetition and may act accordingly.

In some embodiments, some of the above embodiments may also applicable to the feature “Non-SDT”. To be specific, when the RSRP for DL pathloss reference is higher than or equal to a repetition threshold, the UE 110 may select PRACH resource (e.g., a specific PRACH preamble and/or specific PRACH occasion) for its PRACH transmission, and upon detection of the PRACH transmission over the selected PRACH resource, the gNB 120 may determine that the UE 110 is requesting for SDT and may act accordingly.

With these embodiments, effective selection of SSB and PRACH resources in a network when a specific feature is enabled may be achieved, so that UEs can be improved with the enabled feature while legacy UE is not affected.

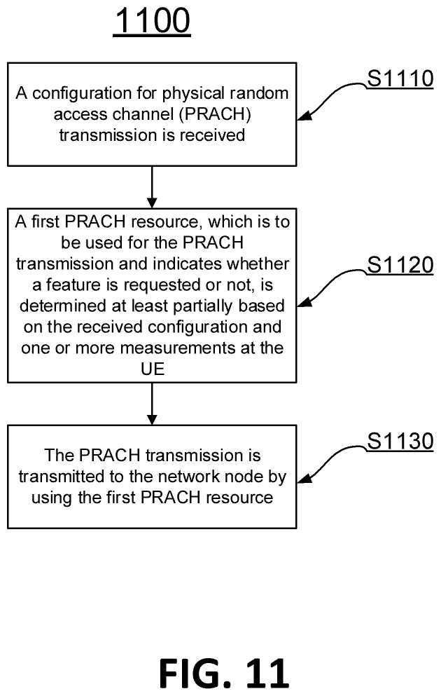

FIG. 11 is a flow chart of an exemplary method 1100 at a UE for feature based PRACH transmission according to an embodiment of the present disclosure. The method 1100 may be performed at a user equipment (e.g., the UE 110). The method 1100 may comprise step S1110, S1120, and step S1130. However, the present disclosure is not limited thereto. In some other embodiments, the method 1100 may comprise more steps, less steps, different steps or any combination thereof. Further the steps of the method 1100 may be performed in a different order than that described herein. Further, in some embodiments, a step in the method 1100 may be split into multiple sub-steps and performed by different entities, and/or multiple steps in the method 1100 may be combined into a single step.

The method 1100 may begin at step S1110 where a configuration for physical random access channel (PRACH) transmission may be received.

At step S1120, a first PRACH resource, which is to be used for the PRACH transmission and indicates whether a feature is requested or not, may be determined at least partially based on the received configuration and one or more measurements at the UE.

At step S1130, the PRACH transmission may be transmitted to the network node by using the first PRACH resource.

In some embodiments, the first PRACH resource may comprise at least one of:—a PRACH time/frequency resource; and—a PRACH preamble sequence. In some embodiments, the feature may comprise at least one of:—Msg3 repetition;—MsgA repetition;—a network slice;—Non-small data transmission (Non-SDT);—a UE with reduced capability (RedCap UE);—a random access in non-terrestrial network; and—a specific service type or UE priority.

In some embodiments, the step of determining the first PRACH resource may comprise: determining whether the feature is requested or not at least partially based on the received configuration and a first measurement at the UE; selecting one of multiple synchronous signal blocks (SSBs) broadcasted by the network node at least partially based on the received configuration and one or more second measurements at the UE; and determining the first PRACH resource at least partially based on the selected SSB and the determination of whether the feature is requested or not.

In some embodiments, the step of determining whether the feature is requested or not may comprise: determining whether reference signal received power (RSRP) of a downlink pathloss reference, which is measured at the UE, is higher than or equal to a first threshold indicated by the received configuration or not; and determining that the feature is not requested in response to determining that the RSRP of the downlink pathloss reference is higher than or equal to the first threshold. In some embodiments, the step of determining whether the feature is requested or not may comprise: determining whether RSRP of a downlink pathloss reference, which is measured at the UE, is higher than or equal to a first threshold indicated by the received configuration or not; and determining that the feature is requested in response to determining that the RSRP of the downlink pathloss reference is lower than the first threshold.

In some embodiments, the selected SSB may be one of:—a first SSB that is first determined to have a measured RSRP higher than a second threshold indicated by the received configuration;—a second SSB that is first determined to have a measured RSRP higher than a third threshold indicated by the received configuration;—a third SSB having the highest measured RSRP that is higher than the second threshold;—a fourth SSB having the highest measured RSRP that is higher than the third threshold;—a fifth SSB having the highest measured RSRP that is lower than or equal to the second threshold;—a sixth SSB having the highest measured RSRP that is lower than or equal to the second threshold but higher than the third threshold;—a seventh SSB having the highest measured RSRP that is lower than or equal to the third threshold; and—an eighth SSB that is randomly selected and has a measured RSRP lower than or equal to the second threshold and/or the third threshold. In some embodiments, the second threshold may be indicated by an information element (IE) “rsrp-ThresholdSSB” in the configuration, and the third threshold may be indicated by a second IE in the configuration or jointly indicated by the IE “rsrp-ThresholdSSB” and a third IE in the configuration that indicates an offset.

In some embodiments, the step of determining the first PRACH resource at least partially based on the selected SSB and the determination of whether the feature is requested or not may comprise at least one of: determining a PRACH resource, which is associated with the selected SSB and indicates the feature is not requested, as the first PRACH resource in response to determining that the feature is not requested and in response to the selected SSB being the first or third SSB; determining a PRACH resource, which is associated with the selected SSB and indicates the feature is not requested, as the first PRACH resource in response to determining that the feature is not requested and in response to the selected SSB being the fifth or eighth SSB; determining a PRACH resource, which is associated with the selected SSB and indicates the feature is requested, as the first PRACH resource in response to determining that the feature is requested and in response to the selected SSB being the first or third SSB; and determining a PRACH resource, which is associated with the selected SSB and indicates the feature is requested, as the first PRACH resource in response to determining that the feature is requested and in response to the selected SSB being the fifth or eighth SSB.

In some embodiments, the step of determining the first PRACH resource at least partially based on the selected SSB and the determination of whether the feature is requested or not may comprise at least one of: determining a PRACH resource, which is associated with the selected SSB and indicates the feature is not requested, as the first PRACH resource in response to determining that the feature is not requested and in response to the selected SSB being the first or third SSB; determining a PRACH resource, which is associated with the selected SSB and indicates the feature is not requested, as the first PRACH resource in response to determining that the feature is not requested and in response to the selected SSB being the fifth or eighth SSB; determining a PRACH resource, which is associated with the selected SSB and indicates the feature is requested, as the first PRACH resource in response to determining that the feature is requested and in response to the selected SSB being the second or fourth SSB; and determining a PRACH resource, which is associated with the selected SSB and indicates the feature is requested, as the first PRACH resource in response to determining that the feature is requested and in response to the selected SSB being the seventh or eighth SSB.

In some embodiments, the step of determining the first PRACH resource at least partially based on the selected SSB and the determination of whether the feature is requested or not may comprise at least one of: determining a PRACH resource, which is associated with the selected SSB and indicates the feature is not requested, as the first PRACH resource in response to determining that the feature is not requested and in response to the selected SSB being the first or third SSB; determining a PRACH resource, which is associated with the selected SSB and indicates the feature is requested, as the first PRACH resource in response to determining that the feature is not requested and in response to the selected SSB being the sixth SSB; determining a PRACH resource, which is associated with the selected SSB and indicates the feature is requested, as the first PRACH resource in response to determining that the feature is requested and in response to the selected SSB being the second or fourth SSB; and determining a PRACH resource, which is associated with the selected SSB and indicates the feature is requested, as the first PRACH resource in response to determining that the feature is requested and in response to the selected SSB being the seventh or eighth SSB.

In some embodiments, after the step of determining whether the feature is requested or not, the method 1100 may further comprise at least one of:—setting the variable “RA_TYPE” at the UE to indicate whether the feature is requested or not, wherein the variable “RA_TYPE” has a value indicating 2-stepRA, 4-stepRA, or 4-stepRA-rep based on the determination;—setting a variable different from the variable “RA TYPE” at the UE to indicate whether its access type is a random access with the feature or not based on the determination; and—setting a variable different from the variable “RA_TYPE” at the UE to indicate whether the UE shall signal, to the network node, that the feature is requested or not based on the determination.

In some embodiments, the step of determining the first PRACH resource may comprise: selecting one of multiple SSBs broadcasted by the network node at least partially based on the received configuration and one or more second measurements at the UE; determining whether the feature is requested or not at least partially based on at least one of:—the received configuration and a first measurement at the UE;—the received configuration and the one or more second measurements at the UE; and—the selected SSB; and determining the first PRACH resource at least partially based on the selected SSB and the determination of whether the feature is requested or not.

In some embodiments, the selected SSB may be one of:—a first SSB that is first determined to have a measured RSRP higher than a second threshold indicated by the received configuration;—a second SSB that is first determined to have a measured RSRP higher than the second threshold or a third threshold indicated by the received configuration;—a third SSB that is first determined to have a measured RSRP higher than a fourth threshold indicated by the received configuration;—a fourth SSB having the highest measured RSRP that is higher than the second threshold;—a fifth SSB having the highest measured RSRP that is higher than the second or third threshold;—a sixth SSB having the highest measured RSRP that is higher than the fourth threshold;—a seventh SSB having the highest measured RSRP that is lower than or equal to the second threshold;—an eighth SSB having the highest measured RSRP that is lower than or equal to both of the second threshold and the third threshold;—a ninth SSB having the highest measured RSRP that is lower than or equal to the fourth threshold; and—a tenth SSB that is randomly selected and has a measured RSRP lower than or equal to the second threshold and/or the third threshold and/or the fourth threshold. In some embodiments, the second threshold may be indicated by an information element (IE) “rsrp-ThresholdSSB” in the configuration, wherein the third threshold may be indicated by a second IE in the configuration or jointly indicated by the IE “rsrp-ThresholdSSB” and a third IE in the configuration that indicates an offset; and wherein the fourth threshold may be indicated by a fourth IE in the configuration.

In some embodiments, the step of determining whether the feature is requested or not may comprise: determining whether RSRP of a downlink pathloss reference, which is measured at the UE, is higher than or equal to a first threshold indicated by the received configuration or not; and determining that the feature is not requested in response to determining that the RSRP of the downlink pathloss reference is higher than or equal to the first threshold.

In some embodiments, the step of determining whether the feature is requested or not may comprise: determining whether RSRP of a downlink pathloss reference, which is measured at the UE, is higher than or equal to a first threshold indicated by the received configuration or not; and determining that the feature is requested in response to determining that the RSRP of the downlink pathloss reference is lower than the first threshold.

In some embodiments, the step of determining whether the feature is requested or not may comprise: determining whether the RSRP of the selected SSB is higher than the third threshold or not; and determining that the feature is requested in response to determining that the RSRP of the selected SSB is lower than or equal to the third threshold.

In some embodiments, the step of determining whether the feature is requested or not may comprise: determining whether the RSRP of the selected SSB is higher than the third threshold or not; and determining that the feature is not requested in response to determining that the RSRP of the selected SSB is higher than the third threshold.

In some embodiments, the step of determining whether the feature is requested or not may comprise: determining that the feature is requested in response to determining that the selected SSB is the eighth SSB.

In some embodiments, the step of determining whether the feature is requested or not may comprise: determining that the feature is not requested in response to determining that the selected SSB is the first or fourth SSB.

In some embodiments, the step of determining whether the feature is requested or not may comprise: determining whether the RSRP of the selected SSB is higher than the third threshold or not; and determining that the feature is requested in response to determining that the RSRP of the selected SSB is higher than the third threshold.

In some embodiments, the step of determining whether the feature is requested or not may comprise: determining whether the RSRP of the selected SSB is higher than or equal to the fourth threshold plus a repetition offset indicated by the received configuration or not; and determining that the feature is not requested in response to determining that the RSRP of the selected SSB is higher than or equal to the fourth threshold plus the repetition offset.

In some embodiments, the step of determining whether the feature is requested or not may comprise: determining whether the RSRP of the selected SSB is higher than or equal to the fourth threshold plus a repetition offset indicated by the received configuration or not; and determining that the feature is requested in response to determining that the RSRP of the selected SSB is lower than the fourth threshold plus the repetition offset.

In some embodiments, the step of determining whether the feature is requested or not may comprise: determining that the feature is requested in response to determining that the RSRP of the selected SSB is lower than the fourth threshold.

In some embodiments, the step of determining the first PRACH resource at least partially based on the selected SSB and the determination of whether the feature is requested or not may comprise at least one of: determining a PRACH resource, which is associated with the selected SSB and indicates the feature is not requested, as the first PRACH resource in response to determining that the feature is not requested and in response to the selected SSB being the first or fourth SSB; determining a PRACH resource, which is associated with the selected SSB and indicates the feature is requested, as the first PRACH resource in response to determining that the feature is requested and in response to the selected SSB being the first or fourth SSB; determining a PRACH resource, which is associated with the selected SSB and indicates the feature is not requested, as the first PRACH resource in response to determining that the feature is not requested and in response to the selected SSB being the seventh or tenth SSB; and determining a PRACH resource, which is associated with the selected SSB and indicates the feature is requested, as the first PRACH resource in response to determining that the feature is requested and in response to the selected SSB being the seventh or tenth SSB.

In some embodiments, the step of determining the first PRACH resource at least partially based on the selected SSB and the determination of whether the feature is requested or not may comprise at least one of: determining a PRACH resource, which is associated with the selected SSB and indicates the feature is not requested, as the first PRACH resource in response to determining that the feature is not requested and in response to the selected SSB being the second or fifth SSB; determining a PRACH resource, which is associated with the selected SSB and indicates the feature is requested, as the first PRACH resource in response to determining that the feature is requested and in response to the selected SSB being the second or fifth SSB; determining a PRACH resource, which is associated with the selected SSB and indicates the feature is requested, as the first PRACH resource in response to determining that the feature is requested and in response to the selected SSB being the eighth or tenth SSB.

In some embodiments, the step of determining the first PRACH resource at least partially based on the selected SSB and the determination of whether the feature is requested or not may comprise at least one of: determining a PRACH resource, which is associated with the selected SSB and indicates the feature is not requested, as the first PRACH resource in response to determining that the feature is not requested and in response to the selected SSB being the first or fourth SSB; determining a PRACH resource, which is associated with the selected SSB and indicates the feature is requested, as the first PRACH resource in response to determining that the feature is requested and in response to the selected SSB being the seventh or tenth SSB.

In some embodiments, the step of determining the first PRACH resource at least partially based on the selected SSB and the determination of whether the feature is requested or not may comprise at least one of: determining a PRACH resource, which is associated with the selected SSB and indicates the feature is not requested, as the first PRACH resource in response to determining that the feature is not requested and in response to the selected SSB being the third or sixth SSB; determining a PRACH resource, which is associated with the selected SSB and indicates the feature is requested, as the first PRACH resource in response to determining that the feature is requested and in response to the selected SSB being the third or sixth SSB; determining a PRACH resource, which is associated with the selected SSB and indicates the feature is requested, as the first PRACH resource in response to determining that the feature is requested and in response to the selected SSB being the ninth or tenth SSB.

In some embodiments, the step of determining the first PRACH resource at least partially based on the selected SSB and the determination of whether the feature is requested or not may comprise: determining a PRACH resource, which indicates the feature is requested, as the first PRACH resource in response to determining that the UE is in a connected state with the network node and at least one pre-defined condition is met.

In some embodiments, the at least one pre-defined condition may comprise at least one of:—the PRACH transmission is used for beam failure recovery (BFR);—the PRACH transmission is used for uplink synchronization;—the PRACH transmission is used for Radio Resource Control (RRC) connection re-establishment; and—the PRACH transmission is used for Scheduling Request (SR) failure.

In some embodiments, before the step of determining the first PRACH resource, the method 1100 may further comprise: receiving, from the network node, an indicator for each of one or more of the at least one pre-defined condition.

In some embodiments, the step of determining the first PRACH resource at least partially based on the selected SSB and the determination of whether the feature is requested or not may comprise: determining a PRACH resource, which indicates the feature is requested, as the first PRACH resource in response to determining that the timing advance (TA) for the UE is changed by a value greater than a TA threshold.

In some embodiments, the step of determining the first PRACH resource at least partially based on the selected SSB and the determination of whether the feature is requested or not may comprise: determining a PRACH resource, which indicates the feature is requested, as the first PRACH resource in response to determining that a distance between the UE and the network node is longer than a distance threshold.

In some embodiments, when the feature is not MsgA repetition, the method 1100 may further comprise: receiving, from the network node, a random access response (RAR) comprising an indicator indicating whether the feature is to be used or not; and transmitting, to the network node, a Msg3 with or without the feature depending on the received indicator.

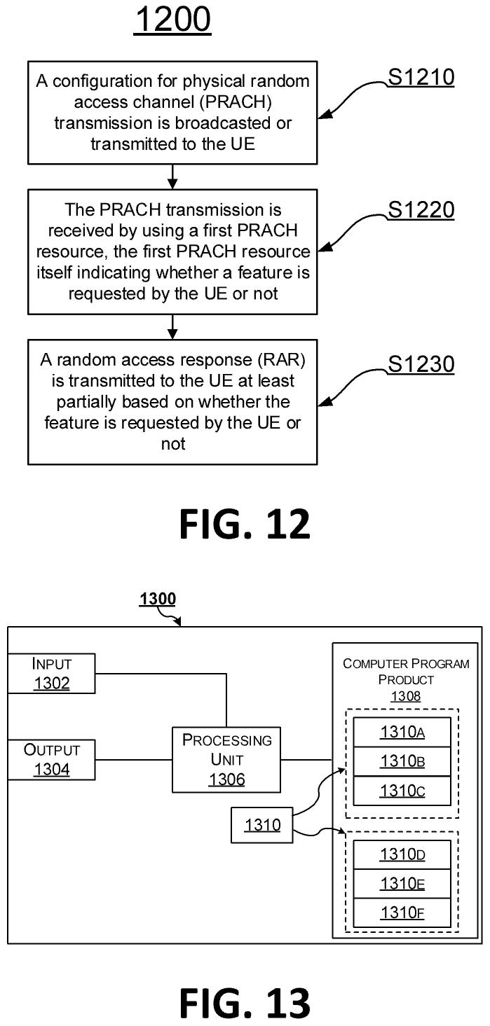

FIG. 12 is a flow chart of an exemplary method 1200 at a network node for feature based PRACH transmission from a UE according to an embodiment of the present disclosure. The method 1200 may be performed at a network node (e.g., the gNB 120). The method 1200 may comprise step S1210, S1220, and step S1230. However, the present disclosure is not limited thereto. In some other embodiments, the method 1200 may comprise more steps, less steps, different steps or any combination thereof. Further the steps of the method 1200 may be performed in a different order than that described herein. Further, in some embodiments, a step in the method 1200 may be split into multiple sub-steps and performed by different entities, and/or multiple steps in the method 1200 may be combined into a single step.

The method 1200 may begin at step S1210 where a configuration for physical random access channel (PRACH) transmission may be broadcasted or transmitted to the UE.

At step S1220, the PRACH transmission may be received by using a first PRACH resource, the first PRACH resource itself indicating whether a feature is requested by the UE or not.

At step S1230, a random access response (RAR) may be transmitted to the UE at least partially based on whether the feature is requested by the UE or not.

In some embodiments, the first PRACH resource may comprise at least one of:—a PRACH time/frequency resource; and—a PRACH preamble sequence. In some embodiments, the feature may comprise at least one of:—Msg3 repetition;—MsgA repetition;—a network slice;—Non-small data transmission (Non-SDT);—a UE with reduced capability (RedCap UE);—a random access in non-terrestrial network; and—a specific service type or UE priority.

In some embodiments, the configuration may comprise at least one of:—a first threshold for determining whether the feature can be requested or not;—a second threshold for both a non-Msg3-repetition-capable UE and a Msg3-repetition-capable UE to determine whether a SSB can be selected or not;—a third threshold for determining, alone or together with the second threshold, whether a SSB can be selected or not when the feature is to be requested; and—a fourth threshold for a Msg3-repetition-capable UE only to determine whether a SSB can be selected or not.

In some embodiments, the method 1200 may further comprise: for each of at least one of following pre-defined conditions, broadcasting or transmitting, to the UE, an indicator to indicate that the feature can be always requested if the corresponding condition is met:—the PRACH transmission is used for beam failure recovery (BFR);—the PRACH transmission is used for uplink synchronization;—the PRACH transmission is used for Radio Resource Control (RRC) connection re-establishment; and—the PRACH transmission is used for Scheduling Request (SR) failure.

In some embodiments, when the feature is not MsgA repetition, the method 1200 may further comprise: receiving, from the UE, a Msg3 with the feature enabled or disabled depending on the RAR.

FIG. 13 schematically shows an embodiment of an arrangement 1300 which may be used in a user equipment (e.g., the UE 110) or a network node (e.g., the gNB 120) according to an embodiment of the present disclosure. Comprised in the arrangement 1300 are a processing unit 1306, e.g., with a Digital Signal Processor (DSP) or a Central Processing Unit (CPU). The processing unit 1306 may be a single unit or a plurality of units to perform different actions of procedures described herein. The arrangement 1300 may also comprise an input unit 1302 for receiving signals from other entities, and an output unit 1304 for providing signal(s) to other entities. The input unit 1302 and the output unit 1304 may be arranged as an integrated entity or as separate entities.

Furthermore, the arrangement 1300 may comprise at least one computer program product 1308 in the form of a non-volatile or volatile memory, e.g., an Electrically Erasable Programmable Read-Only Memory (EEPROM), a flash memory and/or a hard drive. The computer program product 1308 comprises a computer program 1310, which comprises code/computer readable instructions, which when executed by the processing unit 1306 in the arrangement 1300 causes the arrangement 1300 and/or the UE/network node in which it is comprised to perform the actions, e.g., of the procedure described earlier in conjunction with FIG. 4 to FIG. 12 or any other variant.

The computer program 1310 may be configured as a computer program code structured in computer program modules 1310A, 1310B, and 1310C. Hence, in an exemplifying embodiment when the arrangement 1300 is used in a UE, the code in the computer program of the arrangement 1300 includes: a module 1310A for receiving a configuration for physical random access channel (PRACH) transmission; a module 1310B for determining a first PRACH resource, which is to be used for the PRACH transmission and indicates whether a feature is requested or not, at least partially based on the received configuration and one or more measurements at the UE; and a module 1310C for transmitting, to the network node, the PRACH transmission by using the first PRACH resource.

Further, the computer program 1310 may be further configured as a computer program code structured in computer program modules 1310D, 1310E, and 1310F. Hence, in an exemplifying embodiment when the arrangement 1300 is used in a network node, the code in the computer program of the arrangement 1300 includes: a module 1310D for broadcasting or transmitting, to the UE, a configuration for physical random access channel (PRACH) transmission; a module 1310E for receiving the PRACH transmission by using a first PRACH resource, the first PRACH resource itself indicating whether a feature is requested by the UE or not; and a module 1310F for transmitting, to the UE, a random access response (RAR) at least partially based on whether the feature is requested by the UE or not.

The computer program modules could essentially perform the actions of the flow illustrated in FIG. 4 to FIG. 12, to emulate the UE or the network node. In other words, when the different computer program modules are executed in the processing unit 1306, they may correspond to different modules in the UE or the network node.

Although the code means in the embodiments disclosed above in conjunction with FIG. 13 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE and/or the network node.

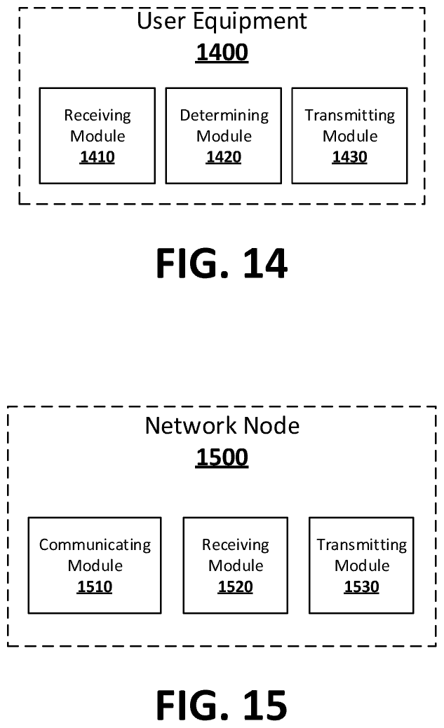

Correspondingly to the method 1100 as described above, an exemplary user equipment is provided. FIG. 14 is a block diagram of a UE 1400 according to an embodiment of the present disclosure. The UE 1400 may be, e.g., the UE 110 in some embodiments.

The UE 1400 may be configured to perform the method 1100 as described above in connection with FIG. 11. As shown in FIG. 14, the UE 1400 may comprise a receiving module 1410 for receiving a configuration for physical random access channel (PRACH) transmission; a determining module 1420 for determining a first PRACH resource, which is to be used for the PRACH transmission and indicates whether a feature is requested or not, at least partially based on the received configuration and one or more measurements at the UE; and a transmitting module 1430 for transmitting, to the network node, the PRACH transmission by using the first PRACH resource.

The above modules 1410, 1420, and/or 1430 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 11. Further, the UE 1400 may comprise one or more further modules, each of which may perform any of the steps of the method 1100 described with reference to FIG. 11.

Correspondingly to the method 1200 as described above, a network node is provided. FIG. 15 is a block diagram of an exemplary network node 1500 according to an embodiment of the present disclosure. The network node 1500 may be, e.g., the gNB 120 in some embodiments.

The network node 1500 may be configured to perform the method 1200 as described above in connection with FIG. 12. As shown in FIG. 15, the network node 1500 may comprise a communicating module 1510 for broadcasting or transmitting, to the UE, a configuration for physical random access channel (PRACH) transmission; a receiving module 1520 for receiving the PRACH transmission by using a first PRACH resource, the first PRACH resource itself indicating whether a feature is requested by the UE or not; and a transmitting module 1530 for transmitting, to the UE, a random access response (RAR) at least partially based on whether the feature is requested by the UE or not.

The above modules 1510, 1520, and/or 1530 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 12. Further, the network node 1500 may comprise one or more further modules, each of which may perform any of the steps of the method 1200 described with reference to FIG. 12.

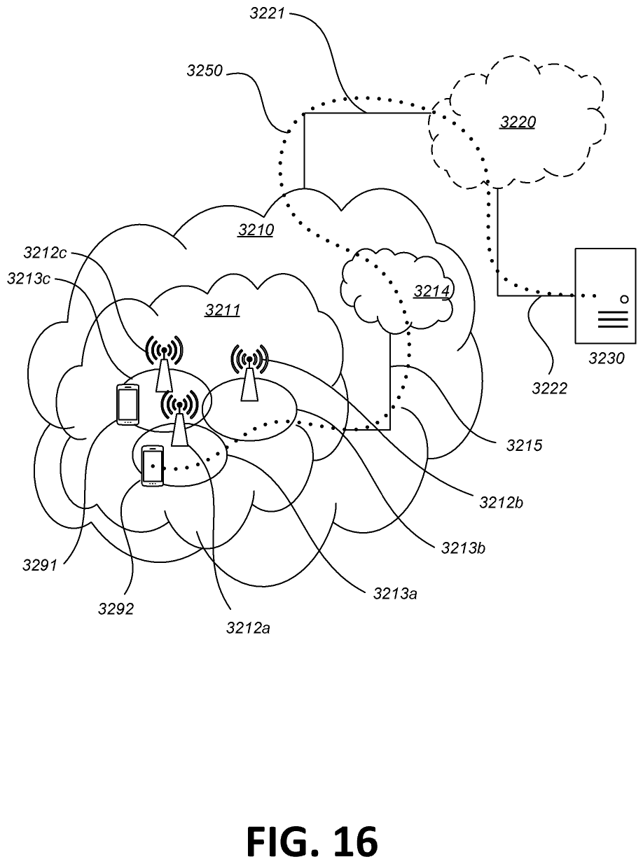

With reference to FIG. 16, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 16 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

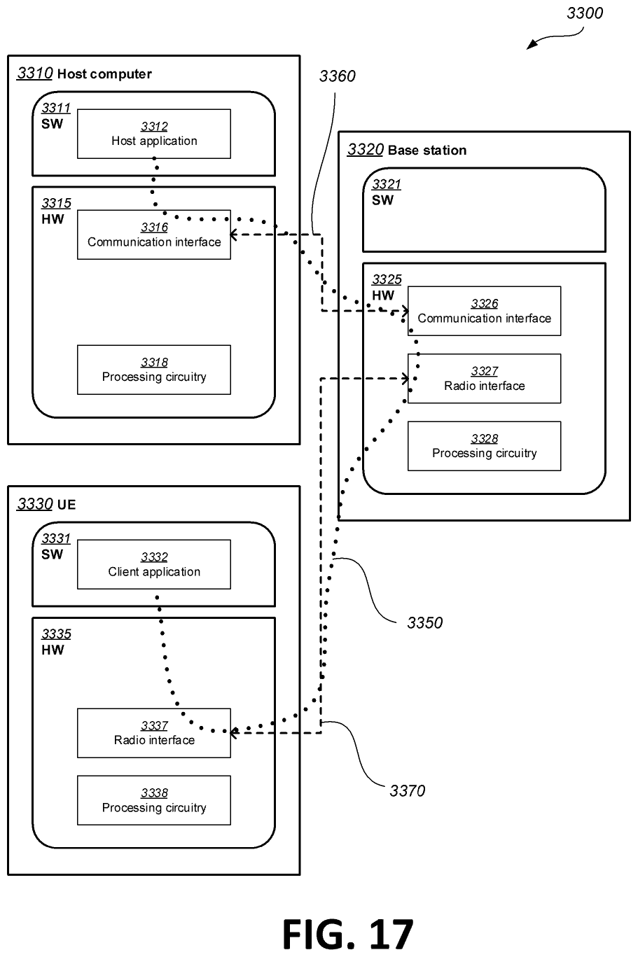

Example implementations, in accordance with an embodiment, of the UE, base station and host computer discussed in the preceding paragraphs will now be described with reference to FIG. 17. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 17) served by the base station 3320. The communication interface 3326 may be configured to facilitate a connection 3360 to the host computer 3310. The connection 3360 may be direct or it may pass through a core network (not shown in FIG. 17) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 17 may be identical to the host computer 3230, one of the base stations 3212a, 3212b, 3212c and one of the UEs 3291, 3292 of FIG. 16, respectively. This is to say, the inner workings of these entities may be as shown in FIG. 17 and independently, the surrounding network topology may be that of FIG. 16.

In FIG. 17, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

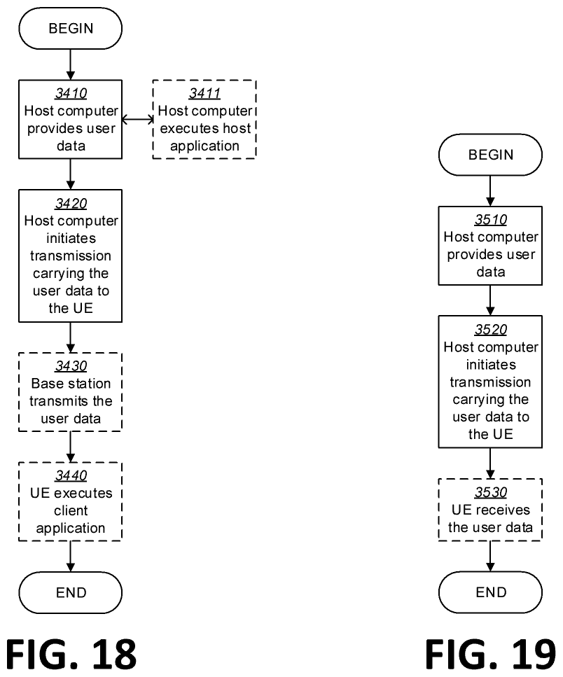

FIG. 18 is a flowchart illustrating a method implemented in a communication system, in accordance with one embodiment. The communication system includes a host computer, a base station and a UE which may be those described with reference to FIG. 16 and FIG. 17. For simplicity of the present disclosure, only drawing references to FIG. 18 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIG. 16 and FIG. 17. For simplicity of the present disclosure, only drawing references to FIG. 19 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

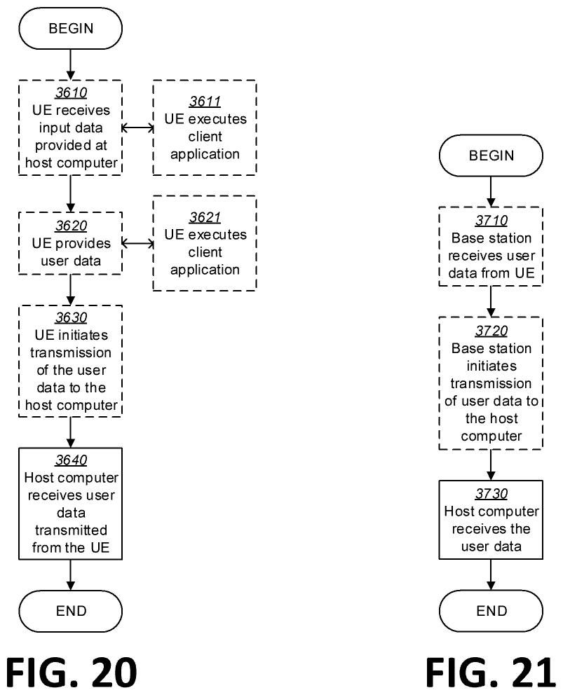

FIG. 20 is a flowchart illustrating a method implemented in a communication system, in accordance with one embodiment. The communication system includes a host computer, a base station and a UE which may be those described with reference to FIG. 16 and FIG. 17. For simplicity of the present disclosure, only drawing references to FIG. 20 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| BFR | Beam Failure Recovery |
| MAC | Medium Access Control |
| SSB | Synchronization Signal Block |
| PRACH | Physical Random Access Channel |
| RACH | Random Access Channel |
| RO | PRACH occasion, i.e. the timing frequency resource used |
| | for one PRACH transmission |
| RRC | Radio Resource Control |
| RSRP | Reference Signal Received Power |
| TA | Timing Advance |

1. A method at a user equipment (UE) for performing a random access procedure with a network node, the method comprising:
receiving a configuration for physical random access channel (PRACH) transmission;
determining a first PRACH resource, which is to be used for the PRACH transmission and indicates whether a feature is requested or not, at least partially based on the received configuration and one or more measurements at the UE; and
transmitting, to the network node, the PRACH transmission by using the first PRACH resource.

2. The method of claim 1, wherein the first PRACH resource comprises at least one of:
a PRACH time/frequency resource; and
a PRACH preamble sequence.

3. The method of claim 1, wherein the feature comprises at least one of:
Msg3 repetition;
MsgA repetition;
a network slice;
Non-small data transmission (Non-SDT);
a UE with reduced capability (RedCap UE);
a random access in non-terrestrial network; and
a specific service type or UE priority.

4. The method of claim 1, wherein the step of determining the first PRACH resource comprises:
determining whether the feature is requested or not at least partially based on the received configuration and a first measurement at the UE;
selecting one of multiple synchronous signal blocks (SSBs) broadcasted by the network node at least partially based on the received configuration and one or more second measurements at the UE; and
determining the first PRACH resource at least partially based on the selected SSB and the determination of whether the feature is requested or not.

5. (canceled)

6. The method of claim 4, wherein the step of determining whether the feature is requested or not comprises:
determining whether RSRP of a downlink pathloss reference, which is measured at the UE, is higher than or equal to a first threshold indicated by the received configuration or not; and
determining that the feature is requested in response to determining that the RSRP of the downlink pathloss reference is lower than the first threshold.

7-11. (canceled)

12. The method of claim 4, wherein after the step of determining whether the feature is requested or not, the method further comprises at least one of:
setting the variable “RA_TYPE” at the UE to indicate whether the feature is requested or not, wherein the variable “RA_TYPE” has a value indicating 2-stepRA, 4-stepRA, or 4-stepRA-rep based on the determination;
setting a variable different from the variable “RA_TYPE” at the UE to indicate whether its access type is a random access with the feature or not based on the determination; and
setting a variable different from the variable “RA_TYPE” at the UE to indicate whether the UE shall signal, to the network node, that the feature is requested or not based on the determination.

13. The method of claim 1, wherein the step of determining the first PRACH resource comprises:
selecting one of multiple SSBs broadcasted by the network node at least partially based on the received configuration and one or more second measurements at the UE;
determining whether the feature is requested or not at least partially based on at least one of:
the received configuration and a first measurement at the UE;
the received configuration and the one or more second measurements at the UE; and
the selected SSB; and
determining the first PRACH resource at least partially based on the selected SSB and the determination of whether the feature is requested or not.

14-29. (canceled)

30. The method of claim 4, wherein the step of determining the first PRACH resource at least partially based on the selected SSB and the determination of whether the feature is requested or not comprises:
determining a PRACH resource, which indicates the feature is requested, as the first PRACH resource in response to determining that the UE is in a connected state with the network node and at least one pre-defined condition is met.

31. The method of claim 30, wherein the at least one pre-defined condition comprises at least one of:
the PRACH transmission is used for beam failure recovery (BFR);
the PRACH transmission is used for uplink synchronization;
the PRACH transmission is used for Radio Resource Control (RRC) connection re-establishment; and
the PRACH transmission is used for Scheduling Request (SR) failure.

32. The method of claim 31, wherein before the step of determining the first PRACH resource, the method further comprises:
receiving, from the network node, an indicator for each of one or more of the at least one pre-defined condition.

33. The method of claim 4, wherein the step of determining the first PRACH resource at least partially based on the selected SSB and the determination of whether the feature is requested or not comprises:
determining a PRACH resource, which indicates the feature is requested, as the first PRACH resource in response to determining that the timing advance (TA) for the UE is changed by a value greater than a TA threshold.

34. The method of claim 4, wherein the step of determining the first PRACH resource at least partially based on the selected SSB and the determination of whether the feature is requested or not comprises:
determining a PRACH resource, which indicates the feature is requested, as the first PRACH resource in response to determining that a distance between the UE and the network node is longer than a distance threshold.

35. The method of claim 4, wherein when the feature is not MsgA repetition, the method further comprises:
receiving, from the network node, a random access response (RAR) comprising an indicator indicating whether the feature is to be used or not; and
transmitting, to the network node, a Msg3 with or without the feature depending on the received indicator.

36. A user equipment, comprising:
a processor;
a memory storing instructions which, when executed by the processor, cause the processor to perform of: receiving a configuration for physical random access channel (PRACH) transmission;
determining a first PRACH resource, which is to be used for the PRACH transmission and indicates whether a feature is requested or not, at least partially based on the received configuration and one or more measurements at the UE; and
transmitting, to the network node, the PRACH transmission by using the first PRACH resource.

37. A method at a network node for performing a random access procedure with a user equipment (UE), the method comprising:
broadcasting or transmitting, to the UE, a configuration for physical random access channel (PRACH) transmission;
receiving the PRACH transmission by using a first PRACH resource, the first PRACH resource itself indicating whether a feature is requested by the UE or not; and
transmitting, to the UE, a random access response (RAR) at least partially based on whether the feature is requested by the UE or not.

38. The method of claim 37, wherein the first PRACH resource comprises at least one of:
a PRACH time/frequency resource; and
a PRACH preamble sequence.

39. The method of claim 37, wherein the feature comprises at least one of:
Msg3 repetition;
MsgA repetition;
a network slice;
Non-small data transmission (Non-SDT);
a UE with reduced capability (RedCap UE);
a random access in non-terrestrial network; and
a specific service type or UE priority.

40. The method of claim 37, wherein the configuration comprises at least one of:
a first threshold for determining whether the feature can be requested or not;
a second threshold for both a non-Msg3-repetition-capable UE and a Msg3-repetition-capable UE to determine whether a SSB can be selected or not;
a third threshold for determining, alone or together with the second threshold, whether a SSB can be selected or not when the feature is to be requested; and
a fourth threshold for a Msg3-repetition-capable UE only to determine whether a SSB can be selected or not.

41. The method of claim 37, further comprising:
for each of at least one of following pre-defined conditions, broadcasting or transmitting, to the UE, an indicator to indicate that the feature can be always requested if the corresponding condition is met:
the PRACH transmission is used for beam failure recovery (BFR);
the PRACH transmission is used for uplink synchronization;
the PRACH transmission is used for Radio Resource Control (RRC) connection re-establishment; and
the PRACH transmission is used for Scheduling Request (SR) failure.

42. The method of claim 37, wherein when the feature is not MsgA repetition, the method further comprises:
receiving, from the UE, a Msg3 with the feature enabled or disabled depending on the RAR.

43-46. (canceled)
